(19) United States
(12) Patent Application Publication
(10) Pub. No.: US 2016/0233921 A1
(43) Pub. Date: Aug. 11, 2016

(54) APPARATUS, SYSTEMS AND METHODS FOR IMPLEMENTING IMPULSE NOISE MITIGATION VIA SOFT SWITCHING

(71) Applicants: Mithat DOGAN, San Jose, CA (US); Mark FLOWERS, Los Gatos, CA (US); Chan-Soo HWANG, Sunnyvale, CA (US); Ming-Yang CHEN, Stanford, CA (US); Goochul CHUNG, San Diego, CA (US); ADAPTIVE SPECTRUM AND SIGNAL ALIGNMENT, INC., Redwood City, CA (US)

(72) Inventors: Mithat DOGAN, San Jose, CA (US); Mark B. FLOWERS, Los Gatos, CA (US); Chan-Soo HWANG, Sunnyvale, CA (US); Ming-Yang CHEN, Stanford, CA (US); Goochul CHUNG, San Diego, CA (US)

(21) Appl. No.: 15/022,778

(22) PCT Filed: Sep. 23, 2013
(86) PCT No.: PCT/US2013/061195

§ 371 Date: Mar. 17, 2016

(51) Int. Cl. H04B 3/32; H04M 11/06; H04L 12/26; H04L 25/08

(52) U.S. Cl. CPC H04B 3/32; H04L 25/085; H04M 11/062; H04L 43/0847

(57) ABSTRACT

Described herein are means for implementing impulse noise detection and mitigation using impulse noise soft switching techniques. For example, such means may include: capturing measurements from one or more reference signals, the measurements corresponding to impulse noise events occurring at the DSL line; classifying the impulse noise events into a plurality of impulse noise classes; computing a blended noise mitigation strategy using one or more of the impulse noise classes; applying impulse noise soft switching to the DSL line using the blended noise mitigation strategy computed; and maintaining the blended noise mitigation strategy at the DSL line for mitigating the impulse noise events on the DSL line. Other related embodiments are disclosed.

### CLAIM FOR PRIORITY

This application claims priority to PCT Patent Application Serial No. PCT/US13/61195, filed on 23 Sep. 2013, titled “APPARATUS, SYSTEMS AND METHODS FOR IMPLEMENTING IMPULSE NOISE MITIGATION VIA SOFT SWITCHING,” and which is incorporated by reference in entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The subject matter described herein relates generally to the field of computing, and more particularly, to apparatuses, systems and methods for implementing impulse noise mitigation via soft switching.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to embodiments of the claimed subject matter.

In the telecommunication arts, Digital Subscriber Lines (DSL lines) provide internet connectivity to subscribers, including residential and business users. In the course of operating a DSL line, it is common for people to turn on and off devices that create impulses affecting communication on the DSL lines. Such impulses are not always present, but when caused by, for example, turning on a device, the impulse noise may completely wipe out transmitted DSL signal communications or cause severe degradation to them. Washers, dryers, microwaves, and other such devices are capable of creating electrical surges that interfere with the DSL communications on a DSL line. To remedy such interference, it is common for error correction code (ECC) to be used, but ECC has a long time span and when combined with interleaving techniques, the ECC and interleaved DSL communication signals result in a long delay (exhibited as latency) because communications must be buffered so that data can be recovered from a damaged signal, resulting in an ongoing latency for ongoing latency that is not acceptable for delay sensitive applications.

Moreover, because the ECC and interleaving may be utilized over a long period of time, it may appear as the modem itself is performing at less than optimal levels. Because ECC adds redundancy, the net rate will be decreased. Should the redundancy owing to the ECC continue to be added, even if there is no impulse noise present, overall operation of the modem will suffer as the redundancy is being introduced to solve a no longer existing problem.

The present state of the art may therefore benefit from apparatuses, systems, and methods for implementing impulse noise mitigation via soft switching as is described herein.

### BRIEF DESCRIPTION OF THE DRAWINGS

Embodiments are illustrated by way of example, and not by way of limitation, and will be more fully understood with reference to the following detailed description when considered in connection with the figures in which:

FIG. 1 illustrates an exemplary architecture in which embodiments may operate;

FIG. 2 illustrates an alternative exemplary architecture in accordance with which embodiments may operate;

FIG. 3 illustrates an alternative exemplary architecture in accordance with which embodiments may operate;

FIG. 4A illustrates an alternative exemplary architecture using local computation and selection in accordance with which embodiments may operate;

FIG. 4B illustrates an alternative exemplary architecture using remote computation and local selection in accordance with which embodiments may operate;

FIG. 4C illustrates an alternative exemplary architecture using remote computation and selection in accordance with which embodiments may operate;

FIG. 4D illustrates an alternative exemplary architecture using minimal local functionality in accordance with which embodiments may operate;

FIG. 5A is a flow diagram illustrating a method for implementing impulse noise mitigation via soft switching in accordance with described embodiments;

FIG. 5B is a flow diagram illustrating a method at a DSL network component for implementing impulse noise mitigation via soft switching in accordance with described embodiments;

FIG. 5C is a flow diagram illustrating a method at a remote host for implementing impulse noise mitigation via soft switching in accordance with described embodiments; and

FIG. 6 shows an alternative diagrammatic representation of a system in accordance with which embodiments may operate, be installed, integrated, or configured.

### DETAILED DESCRIPTION

Described herein are impulse noise soft switching implementations using blended noise mitigation strategies for which per-impulse noise detection and mitigation is not required, relying on impulse noise soft switching instead. For example, according to one embodiment, there are means for mitigating noise on a Digital Subscriber Line (DSL line), in which the means include at least: capturing measurements from one or more reference signals, the measurements corresponding to impulse noise events occurring at the DSL line; classifying the impulse noise events into a plurality of impulse noise classes; computing a blended noise mitigation strategy using one or more of the impulse noise classes; applying impulse noise soft switching to the DSL line using the blended noise mitigation strategy computed; and maintaining the blended noise mitigation strategy at the DSL line for mitigating the impulse noise events on the DSL line.

Implementation and use of blended noise mitigation strategies allows for impulse noise mitigation on a DSL line without having to switch an impulse noise mitigation strategy on and off on a per-impulse event (e.g., referred to herein as soft switching). For instance, a blended noise mitigation strategy may be applied to the DSL line and remain in effect during periods of non-impulse noise and during periods of impulse noise. In such a way, the blended noise mitigation strategy will be applied to the line regardless of whether or not impulse noises are present at any given time. Accordingly, the blended noise mitigation strategy, once applied, may be maintained in effect for the DSL line until a soft switching transition event.

Use of impulse noise soft switching using blended noise mitigation strategies does not require detection of an impulse noise because the mitigation strategy is not changed on a per-impulse noise event basis. Impulse noise soft switching instead may apply a constant strategy over a time interval which is dependent on recent observations (e.g., an observed event or a time triggered event), but the impulse noise soft switching but does not attempt to change the strategy on a per impulse basis.

Because application of impulse noise soft switching does not need to detect an impulse noise event in order to engage cancellation, and because impulse noise soft switching does not need to select an impulse noise event cancellation strategy on a per-impulse basis, it is additionally unnecessary to perform classification on a per-impulse basis. The system performs clustering of observed impulse noise events at a DSL line to compute available impulse noise mitigation strategies, then blends selected impulse noise mitigation strategies as appropriate resulting in a blended noise mitigation strategy, and then applies the blended noise mitigation strategy to the DSL line to mitigate impulses.

Such “soft switching” functionality may, however, require additional processing to arrive upon the blended noise mitigation strategy. For instance, in order to derive a quasi-static impulse mitigation strategy, such as that which is used with the soft switching technique, a blended noise mitigation strategy is computed that is capable of targeting multiple impulse noise classifications and handling edge effects that may occur due to lack of per-impulse switching at the impulse beginning and end points. Such computations are distinct from per-impulse noise event mitigation strategies as they are designed to accommodate periods of both impulse noise and non-impulse noise on the DSL line, rather than targeting a single impulse noise event.

According to a particular embodiment, an impulse detector may optionally be utilized to detect impulse noises for triggering waveform captures using multiple references. Unlike per-impulse noise techniques, however, such detected waveforms may be utilized for the purposes of clustering and calculation of one or more blended noise mitigation strategies that are then applied to a subject DSL line using soft switching functionality rather than per-impulse noise detection and mitigation strategies applied on a per-impulse basis. For instance, while the impulse detector may be utilized to trigger application of the per-impulse mitigation techniques, it is not used to trigger application of soft switching techniques. Rather, in the case of soft switching, an impulse detector may be used to trigger capturing of measurements of impulse noise and non-impulse noise occurring at the DSL line. Such measurements are used to create a population of exemplary impulse and non-impulse noise occurring at the DSL line from which the blended noise mitigation strategies may then be computed.

The impulse detector may be applied as, for example, a multiple input single output impulse detector or a “Lego-style” impulse detector which aggregates signals from multiple single channel detectors. Such an impulse detector may further improve impulse noise event detection based on previously identified classifications of impulse noise events. The impulse detector is utilized to detect the impulse noise events on the DSL line and may reside at a DSL network component coupled with the DSL line or may alternatively reside at a remote location which analyzes DSL signals, such as captured waveforms, for the DSL impulse noise events occurring at the DSL line.

Computation of blended noise mitigation strategies may be based upon clustering of previously observed impulse noise event types that have been classified into groups based at least in part on characteristics extracted from each of the observed impulse noise events or event types.

According to certain embodiments, soft switching functionality additionally determines which known classifications have a greatest negative impact on the DSL line due to, for example, a function of frequency of occurrence, peak power, duration, and energy, in contrast to quasi-stationary interference such as AM radio signals and cross-talk whose effects tend to change less frequently. For instance, time stamps associated with captured impulse noise event measurements from the DSL line may be utilized to determine periodicity, frequency, etc.

In certain embodiments, a CPE side modem, DSL signal booster, DSL line card, or other DSL network component interfaced to the DSL line operates independently and perform impulse noise mitigation without the aid of a remote system. In other embodiments, such DSL network components operate under the guidance of a remote system, which instructs the DSL network component to apply soft switching to the DSL line. Where remote communication is enabled, the local DSL network components may capture measurements at the DSL line, send the measurements to a remote system which then performs classification and computation of the blended noise mitigation strategies, and then instructs the local DSL network components to implement soft switching using blended noise mitigation strategies computed by the remote system using locally capture measurements. In such a way, the functionality required to implement impulse noise soft switching may be architected at a local DSL network component, at a remote system which instructs the local DSL network component, or partially performed by each of a remote and a local component.

Certain embodiments combine statistics from multiple impulse noise classifications by mixing coefficients to determine a set of filter coefficients for multiple reference channels to mitigate impulse events that belong to the different classifications considered to be the most harmful for the DSL line.

For instance, sometimes different kinds of impulse types may have different occurrence probabilities (e.g., periodic vs. aperiodic or high vs. low Impulse to Noise Ratio (INR), and so forth). Accordingly, weightings may be utilized when combing statistics to yield the desired filter coefficients.

Such a technique may enable the suppression of two different impulse noise classifications, such as one periodic and one aperiodic, by varying the mixing coefficients. Further still, the capability to arbitrate a trade-off between suppressing two different impulse types may further improve the blended noise mitigation strategy, for instance, where one has equal mixing and a second one that favors the non-periodic impulse type, resulting in equal suppression for both types of impulse noise classifications. Such techniques enable as high as possible suppression gain for the DSL line despite mixing different coefficients corresponding to differing impulse noise classifications. Other considerations for mixing coefficients may be based on estimated negative impact to a DSL line, periodicity of impulse noise event occurrence, and probability of occurrence per impulse noise classification.

Additional inputs may be utilized in determining the blended noise mitigation strategy for use with soft switching, such as incorporation of a portion of edge data adjacent to an impulse noise event, crosstalk noise, or other static or quasi-static noise taken from the reference signals.

In certain embodiments, filter coefficients are determined from only a single reference whereas in others, multiple reference signals are utilized, such as a multichannel filter structure which provides multiple distinct reference signals for use in computing the blended noise mitigation strategy.

Although a deployed blended noise mitigation strategy is maintained for a DSL line full time, that is, without switching on and off on for each impulse noise event occurrence, it is desirable to update the blended noise mitigation strategy over time based on the occurrence of a soft switching transition event, which may include changes to impulse noise classifications that evolve over time due to a change in the impulse environment and thus, cause a change to filter coefficients and in turn the resulting blended noise mitigation strategies available for a DSL line. Accordingly, operational data may be collected as part of monitoring a DSL line so that appropriate transitions may be triggered. For instance, operational data before and after implementation of a given blended noise mitigation strategy may be compared, or operational data may be monitored against one or more thresholds which in turn trigger a soft switching transition event. The DSL line may also be monitored to validate the effectiveness of a newly applied blended noise mitigation strategy. For example, it would not be appropriate to maintain a blended noise mitigation strategy that is observed to deteriorate DSL line performance regardless of estimated effectiveness prior to application of the blended noise mitigation strategy.

If impulse noise cancellation is important to performance of the DSL line and impulse noise events occurring at the DSL line overwhelm the degrees of freedom by the soft switching (e.g., non-switched) impulse canceller resulting in degraded performance of the DSL line, then the per-impulse event mitigation may be engaged in place of soft switching. If impulse noise cancellation is important to performance of the DSL line, but the degrees of freedom by the soft switching (e.g., non-switched) impulse canceller proves sufficient to yield performance gains comparable to per-impulse event mitigation, then the less resource intensive soft switching may be selected as a first preference. Moreover, DSL network components having limited computational resources or lacking an impulse noise detector may not be able to perform per-impulse event mitigation, regardless of whether or not soft switching is sufficient.

In certain embodiments, multiple blended noise mitigation strategies are provided and rules are established to trigger soft switching transition events between the available blended noise mitigation strategies based on, for example, impulse events that are observed to occur in disjoint times, such as different days (e.g., weekend vs. weekday, day vs. night), different times of the year, different hours of the day, and so forth.

In certain embodiments where long impulses are detected on a DSL line, a DSL network component which communicates with a remote host may transmit cross-correlation statistics to the remote host rather than transmitting waveforms. For short impulses, waveforms may be utilized as computing the cross-correlation statistics in place of the waveforms may yield an insufficient resource savings.

Periodic impulses may be categorized locally within a signal booster box coupled with a CPE modem and only non-periodic impulse waveforms or statistics per impulse are then transmitted to a remote host for further analysis and assistance.

According to a particular embodiment, a no-impulse class is represented as one class for stationary noise contributions to the DSL line and the blended noise mitigation strategy computed includes at least one impulse noise class for which an impulse noise event is known to have occurred and in which the blended noise mitigation strategy further includes the no-impulse class. All impulse noise classes include at least some stationary noise, however, use of a no-impulse class may benefit a blended noise mitigation strategy by yielding filter coefficients that can better accommodate long periods void of any such impulse noises on the DSL line.

In certain embodiments, one or more references or reference channels are used in accordance with a given blended noise mitigation strategy. A reference or reference channel is separate from a primary channel used to carry the DSL communication (e.g., payload data and other information transmitted on the DSL line pursuant to providing DSL services to a DSL subscriber). Impulse noise characteristics may be identified based on the primary channel or the references/reference channels, or both.

Certain entities may provide impulse noise detection and mitigation through the provisioning of a so enabled device, such as a DSL modem, an appropriate DSL modem chipset, a signal optimizer communicatively interfaced between a DSL modem and a DSL line, or via a service which performs computation and optimization instructions for a DSL service subscriber. In some embodiments, such a service is provided in conjunction with a compatible device as is described herein.

Impulse noise detection and mitigation services may be provided by a third party, distinct from the DSL operator which provides the DSL services to the DSL service subscriber. For instance, such a service provider may compute and provide the blended noise mitigation strategy to a DSL network component in an attempt to mitigate impulse noises so that an operator of the DSL service sees a minimum of the impulse noise or potentially none at all. Monitoring lines, pre-qualifying lines, or both for the sake of impulse cancellation and mitigation may further benefit application layer controls (e.g. ARQ), regardless of whether or not hardware is deployed. For example, such monitoring and pre-qualification could help shape a deployment strategy so that more expensive and sophisticated hardware is deployed in those locations where the most benefit can be attained, and locations which are determined to have a lesser benefit could be delayed or simply not selected. Further still, monitoring of lines may provide further data points upon which effectiveness of deployed impulse noise mitigation hardware can be evaluated or by which locations in need of such hardware could be identified as the operational landscape of DSL system changes over time. Where utilized, impulse noise mitigation via the soft switching techniques described improves customer experience for the DSL subscriber through improved and more reliable performance, and by extension, improves business conditions for the DSL operator through enhanced customer satisfaction and decreased technical support for intermittent communication faults or degraded DSL modem performance.

A third party service provider of impulse noise mitigation services may additionally pass information to upper communication layers (e.g., ARQ) so that the upper layers can customize better solutions for the impulse noise cancellation. In practice, even where impulse noise cancellation (INC) hardware is present, it may nevertheless be beneficial to jointly optimize ECC, INC, or even ECC, INC, and ARQ. Therefore, data collected from the monitoring of lines, may be utilized to optimize ECC and ARQ operational parameters, such that upper layers can customize their solutions by combining INC/ECC/ARQ for the best possible performance of a customer's active DSL line.

In the following description, numerous specific details are set forth such as examples of specific systems, languages, components, etc., in order to provide a thorough understanding of the various embodiments. It will be apparent, however, to one skilled in the art that these specific details need not be employed to practice the disclosed embodiments. In other instances, well known materials or methods have not been described in detail in order to avoid unnecessarily obscuring the disclosed embodiments.

In addition to various hardware components depicted in the figures and described herein, embodiments further include various operations which are described below. The operations described in accordance with such embodiments may be performed by hardware components or may be embodied in machine-executable instructions, which may be used to cause a general-purpose or special-purpose processor programmed with the instructions to perform the operations. Alternatively, the operations may be performed by a combination of hardware and software, including software instructions that perform the operations described herein via memory and one or more processors of a computing platform.

Embodiments also relate to a system or apparatus for performing the operations herein. The disclosed system or apparatus may be specially constructed for the required purposes, or it may comprise a general purpose computer selectively activated or reconfigured by a computer program stored in the computer. Such a computer program may be stored in a non-transitory computer readable storage medium, such as, but not limited to, any type of disk including floppy disks, optical disks, flash, NAND, solid state drives (SSDs), CD-ROMs, and magnetic-optical disks, read-only memories (ROMs), random access memories (RAMs), EPROMs, EEPROMs, magnetic or optical cards, or any type of media suitable for storing non-transitory electronic instructions, each coupled to a computer system bus. In one embodiment, a non-transitory computer readable storage medium having instructions stored thereon, causes one or more processors within an apparatus to perform the methods and operations which are described herein. In another embodiment, the instructions to perform such methods and operations are stored upon a non-transitory computer readable medium for later execution.

The algorithms and displays presented herein are not inherently related to any particular computer or other apparatus nor are embodiments described with reference to any particular programming language. It will be appreciated that a variety of programming languages may be used to implement the teachings of the embodiments as described herein.

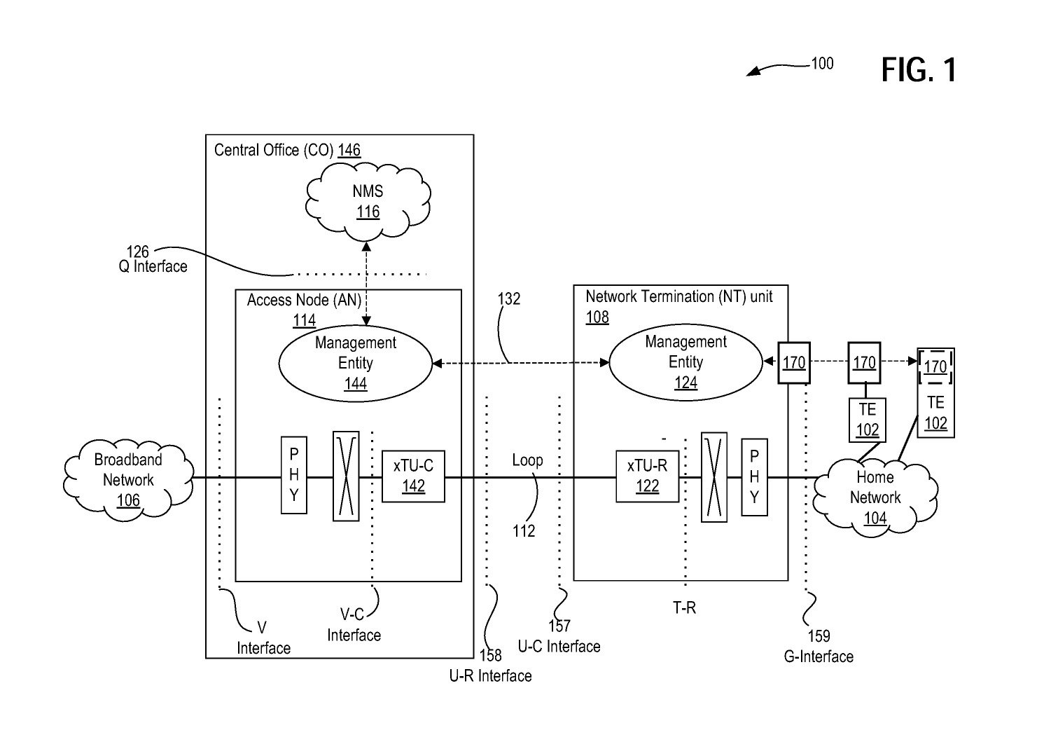

FIG. 1 illustrates an exemplary architecture 100 in which embodiments may operate in compliance with the G.997.1 standard (also known as G.ploam). Asymmetric Digital Subscriber Line (ADSL) systems (one form of Digital Subscriber Line (DSL) systems), which may or may not include splitters, operate in compliance with the various applicable standards such as ADSL1 (G.992.1), ADSL-Lite (G.992.2), ADSL2 (G.992.3), ADSL2-Lite G.992.4, ADSL2+(G.992.5) and the G.993.x emerging Very-high-speed Digital Subscriber Line or Very-high-bitrate Digital Subscriber Line (VDSL) standards, as well as the G.991.1 and G.991.2 Single-Pair High-speed Digital Subscriber Line (SHDSL) standards, all with and without bonding.

The G.997.1 standard specifies the physical layer management for ADSL transmission systems based on the clear, Embedded Operation Channel (EOC) defined in G.997.1 and use of indicator bits and EOC messages defined in the G.992.x, G.993.x and G.998.4 standards. Moreover, G.997.1 specifies network management elements content for configuration, fault and performance management. In performing the disclosed functions, systems may utilize a variety of operational data (which includes performance data) that is available at an Access Node (AN).

In FIG. 1, user's terminal equipment 102 (e.g., a Customer Premises Equipment (CPE) device or a remote terminal device, network node, LAN device, etc.) is coupled to a home network 104, which in turn is coupled to a Network Termination (NT) Unit 108. Multiple xTU devices (“all Transceiver Unit” devices) are further depicted. An xTU provides modulation for a DSL loop or line (e.g., DSL, ADSL, VDSL, etc.). In one embodiment, NT unit 108 includes an xTU-R (xTU Remote), 122 (for example, a transceiver defined by one of the ADSL or VDSL standards) or any other suitable network termination modem, transceiver or other communication unit. NT unit 108 also includes a Management Entity (ME) 124. Management Entity 124 may be any suitable hardware device, such as a microprocessor, microcontroller, or circuit state machine in firmware or hardware, capable of performing as required by any applicable standards and/or other criteria. Management Entity 124 collects and stores, among other things, operational data in its Management Information Base (MIB), which is a database of information maintained by each ME capable of being accessed via network management protocols such as Simple Network Management Protocol (SNMP), an administration protocol used to gather information from a network device to provide to an administrator console/program; via Transaction Language 1 (TL1) commands, TL1 being a long-established command language used to program responses and commands between telecommunication network elements; or via a TR-69 based protocol. “TR-69” or “Technical Report 069” is in reference to a DSL Forum technical specification entitled CPE WAN Management Protocol (CWMP) which defines an application layer protocol for remote management of end-user devices. XML or “eXtended Markup Language” compliant programming and interface tools may also be used.

Each xTU-R 122 in a system may be coupled with an xTU-C (xTU Central) in a Central Office (CO) or other central location. The xTU-C 142 is located at an Access Node (AN) 114 in Central Office 146. A Management Entity (ME) 144 likewise maintains an MIB of operational data pertaining to xTU-C 142. The Access Node 114 may be coupled to a broadband network 106 or other network, as will be appreciated by those skilled in the art. Each of xTU-R 122 and xTU-C 142 are coupled together by a U-interface/loop 112, which in the case of ADSL may be a twisted pair line, such as a telephone line, which may carry other communication services besides DSL based communications. Apparatus 170 may be managed or operated by a service provider of the DSL services or may be operated by a third party, separate from the entity which provides DSL services to end-users. Thus, in accordance with one embodiment apparatus 170 is operated and managed by an entity which is separate and distinct from a telecommunications operator responsible for a plurality of digital communication lines. Management Entity 124 or Management Entity 144 may further store information collected from apparatus 170 within an associated MIB.

Several of the interfaces shown in FIG. 1 are used for determining and collecting operational data. The Q interface 126 provides the interface between the Network Management System (NMS) 116 of the operator and ME 144 in Access Node 114. Parameters specified in the G.997.1 standard apply at the Q interface 126. The near-end parameters supported in Management Entity 144 may be derived from xTU-C 142, while far-end parameters from xTU-R 122 may be derived by either of two interfaces over the U-interface. Indicator bits and EOC messages may be sent using embedded channel 132 and provided at the Physical Medium Dependent (PMD) layer, and may be used to generate the required xTU-R 122 parameters in ME 144. Alternately, the Operations, Administration and Maintenance (OAM) channel and a suitable protocol may be used to retrieve the parameters from xTU-R 122 when requested by Management Entity 144. Similarly, the far-end parameters from xTU-C 142 may be derived by either of two interfaces over the U-interface. Indicator bits and EOC message provided at the PMD layer may be used to generate the required xTU-C 142 parameters in Management Entity 124 of NT unit 108. Alternately, the OAM channel and a suitable protocol may be used to retrieve the parameters from xTU-C 142 when requested by Management Entity 124.

At the U-interface (also referred to as loop 112), there are two management interfaces, one at xTU-C 142 (the U-C interface 157) and one at xTU-R 122 (the U-R interface 158). The U-C interface 157 provides xTU-C near-end parameters for xTU-R 122 to retrieve over the U-interface/loop 112. Similarly, the U-R interface 158 provides xTU-R near-end parameters for xTU-C 142 to retrieve over the U-interface/loop 112. The parameters that apply may be dependent upon the transceiver standard being used (for example, G.992.1 or G.992.2). The G.997.1 standard specifies an optional Operation, Administration, and Maintenance (OAM) communication channel across the U-interface. If this channel is implemented, xTU-C and xTU-R pairs may use it for transporting physical layer OAM messages. Thus, the xTU transceivers 122 and 142 of such a system share various operational data maintained in their respective MIBs.

Depicted within FIG. 1 is apparatus 170 operating at various optional locations in accordance with several alternative embodiments. For example, in accordance with one embodiment, apparatus 170 is located within user's terminal equipment 102 connecting the DSL line to a LAN which establishes home network 104. Alternatively, the apparatus 170 may be connected with the phone line that supplies the DSL connection and the apparatus 170 then in turn connects with the user's terminal equipment 102 which then is connected to a LAN which establishes home network 104. In one embodiment apparatus 170 operates as a DSL modem, such as a Customer Premises (CPE) modem. In another embodiment, apparatus 170 operates as a controller card or as a chipset within a user's terminal equipment 102 (e.g., a Customer Premises Equipment (CPE) device or a remote terminal device, network node, etc.) connecting the DSL line to the home network 104 as depicted. In another embodiment, apparatus 170 operates as a separate and physically distinct stand alone unit which is connected between the user's terminal equipment 102 and a DSL line or loop. For example, apparatus 170 may operate as a stand-alone signal conditioning device. In yet another embodiment, apparatus 170 is connected with a NT unit 108 or with xTU-R 122 over the G-interface 159.

As used herein, the terms “user,” “subscriber,” and/or “customer” refer to a person, business and/or organization to which communication services and/or equipment are and/or may potentially be provided by any of a variety of service provider(s). Further, the term “customer premises” refers to the location to which communication services are being provided by a service provider. For an example Public Switched Telephone Network (PSTN) used to provide DSL services, customer premises are located at, near and/or are associated with the network termination (NT) side of the telephone lines. Example customer premises include a residence or an office building.

As used herein, the term “service provider” refers to any of a variety of entities that provide, sell, provision, troubleshoot and/or maintain communication services and/or communication equipment. Example service providers include a telephone operating company, a cable operating company, a wireless operating company, an internet service provider, or any service that may independently or in conjunction with a broadband communications service provider offer services that diagnose or improve broadband communications services (DSL, DSL services, cable, etc.).

Additionally, as used herein, the term “DSL” refers to any of a variety and/or variant of DSL technology such as, for example, Asymmetric DSL (ADSL), High-speed DSL (HDSL), Symmetric DSL (SDSL), and/or Very high-speed/Very high-bit-rate DSL (VDSL). Such DSL technologies are commonly implemented in accordance with an applicable standard such as, for example, the International Telecommunications Union (I.T.U.) standard G.992.1 (a.k.a. G.dmt) for ADSL modems, the I.T.U. standard G.992.3 (a.k.a. G.dmt.bis, or G.adsl2) for ADSL2 modems, I.T.U. standard G.992.5 (a.k.a. G.adsl2plus) for ADSL2+ modems, I.T.U. standard G.993.1 (a.k.a. G.vdsl) for VDSL modems, I.T.U. standard G.993.2 for VDSL2 modems, I.T.U. standard G.993.5 for DSL modems supporting Vectoring, I.T.U. standard G.998.4 for DSL modems supporting retransmission functionality, I.T.U. standard G.994.1 (G.hs) for modems implementing handshake, and/or the I.T.U. G.997.1 (a.k.a. G.ploam) standard for management of DSL modems.

References to connecting a DSL modem and/or a DSL communication service to a customer are made with respect to exemplary Digital Subscriber Line (DSL) equipment, DSL services, DSL systems and/or the use of ordinary twisted-pair copper telephone lines for distribution of DSL services, it should be understood that the disclosed methods and apparatus to characterize and/or test a transmission medium for communication systems disclosed herein may be applied to many other types and/or variety of communication equipment, services, technologies and/or systems. For example, other types of systems include wireless distribution systems, wired or cable distribution systems, coaxial cable distribution systems, Ultra High Frequency (UHF)/Very High Frequency (VHF) radio frequency systems, satellite or other extra-terrestrial systems, cellular distribution systems, broadband power-line systems and/or fiber optic networks. Additionally, combinations of these devices, systems and/or networks may also be used. For example, a combination of twisted-pair and coaxial cable interfaced via a balun connector, or any other physical-channel-continuing combination such as an analog fiber to copper connection with linear optical-to-electrical connection at an Optical Network Unit (ONU) may be used.

The phrases “coupled to,” “coupled with,” connected to,” “connected with” and the like are used herein to describe a connection between two elements and/or components and are intended to mean coupled/connected either directly together, or indirectly, for example via one or more intervening elements or via a wired/wireless connection. References to a “communication system” are intended, where applicable, to include reference to any other type of data transmission system.

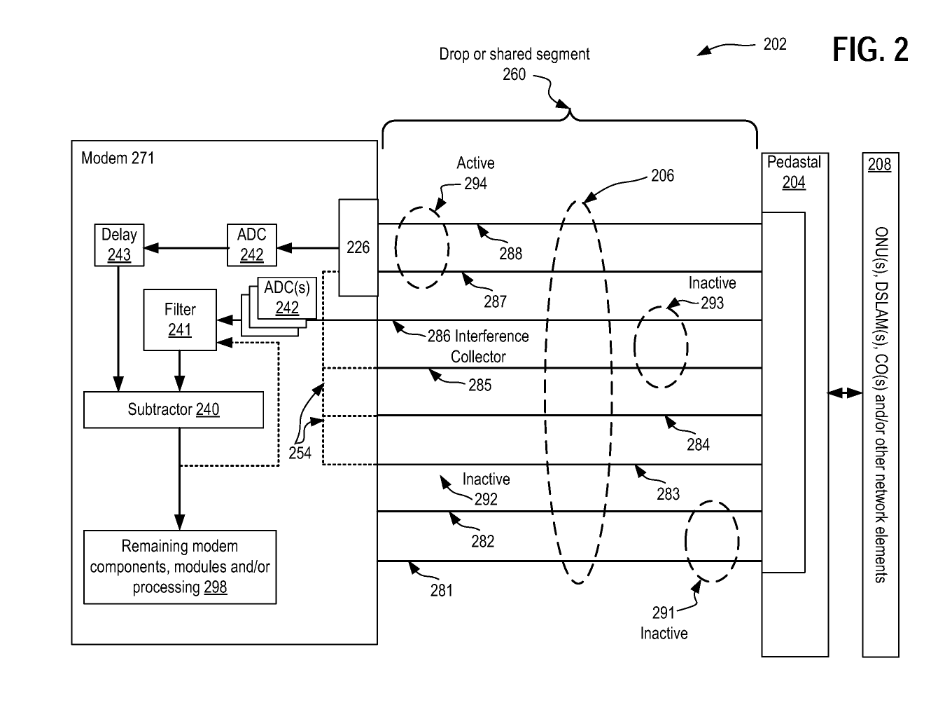

FIG. 2 illustrates an alternative exemplary architecture 202 in accordance with which embodiments may operate. Specifically, an apparatus is depicted as a CPE modem 271 in accordance with at least on embodiment. Such an apparatus, for instance, may correspond to the apparatus 170 of FIG. 1. The figure provides a schematic block diagram having the relevant portions of a DSL modem operating with multiple DSL lines/loops coupled to the modem and implementing one or more methods, systems and/or other embodiments set forth herein.

In one embodiment, the CPE modem 271 is connected with multiple telephone lines or DSL lines, as shown, for example, in the drop or shared segment 260 between pedestal 204 and CPE modem 271. Pedestal 204 is further interfaced to ONU(s), DSLAM(s), CO(s) and/or other network elements 208 as shown.

According to one embodiment, one or more wires of the DSL lines connecting the CPE modem 271 to the pedestal 204 may be used as an interference collector, for example, the wires may be utilized to receive and impulse noise for detection or other radio frequency (RF) noise. In the depicted embodiment, CPE modem 271 is connected to pedestal 204 by a multiple loop segment 206 of shared segment 260 having, in this depicted embodiment, 8 wires 281 through 288, which represent the 8 wires (281, 282, 283, 284, 285, 286, 287, and 288) of 4 loops (291, 292, 293, and 294), resulting in multiple loop segment 206 of shared segment 260.

In the example shown, only loop 294 (using wires 287 and 288) is active, with loops 291, 292, and 293 each being inactive. Thus wires 281 through 286 are not in use for DSL communication purposes, that is, they are not active DSL lines and do not carry a DSL signal. Instead, at least one of these wires, wire 286, is used as an interference collector for CPE modem 271. In this case, wire 286 is practically identical to wires 287 and 288 of active loop 294 (for example, being approximately the same length and having the same orientation, possibly being the same material/type of wire, and possibly having the same amount or absence of shielding) given that it is within the same drop or shared segment 260. This means that wire 286 will receive practically identical RF and/or other interference signals as those received by loop 294. Where more than one source of RF and/or other interference (for example, crosstalk from one or more additional DSL lines) is present, additional inactive loops' wires can be connected with interface 226 and used similarly, if desired.

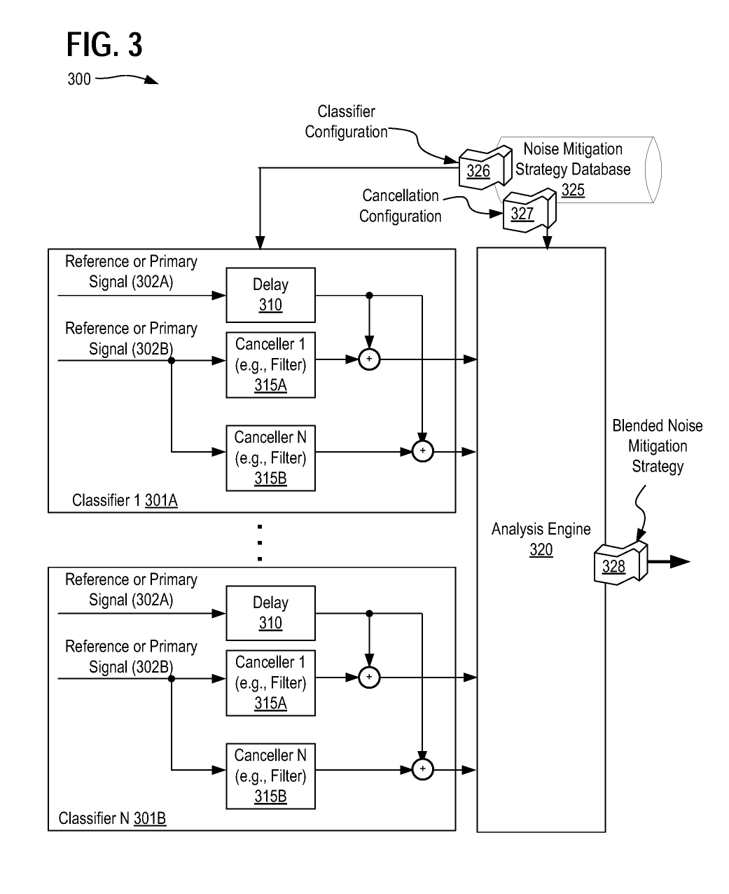

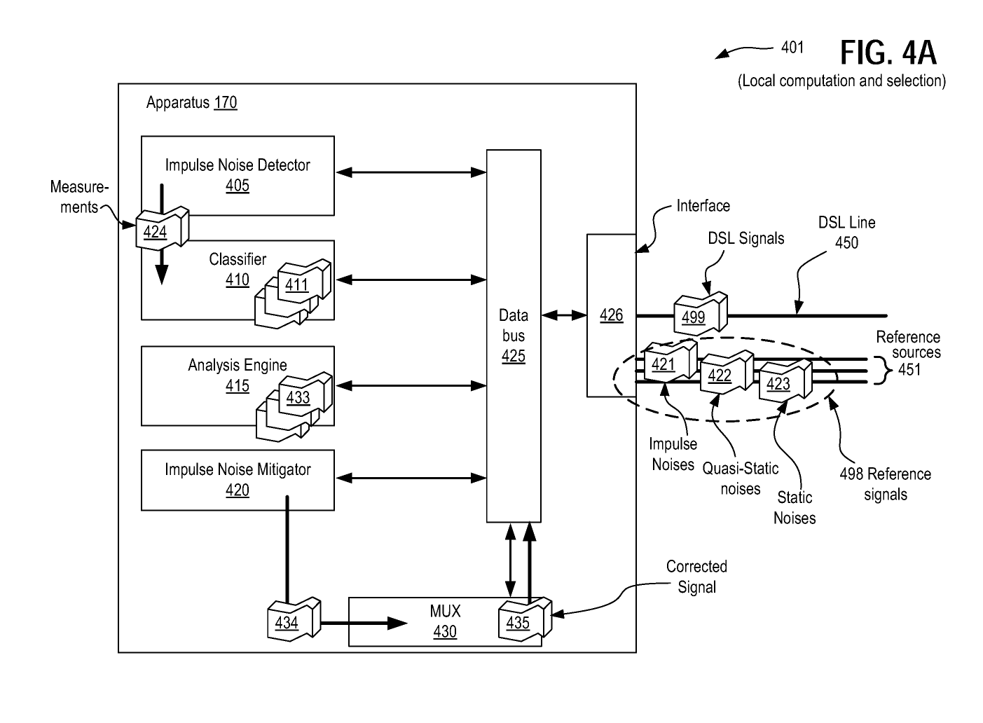

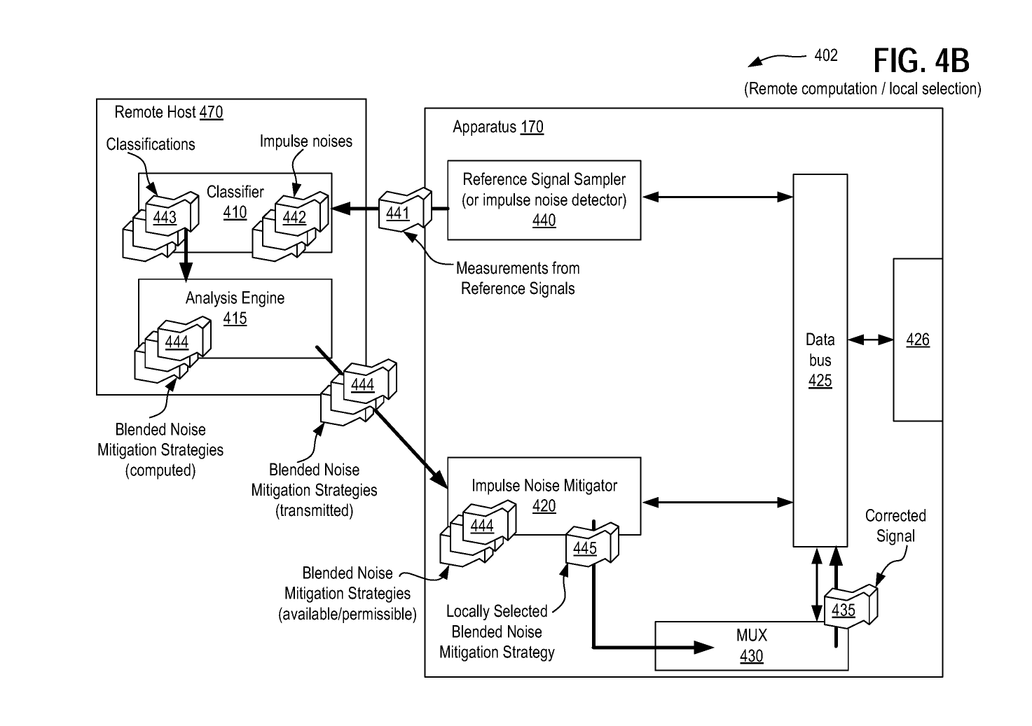

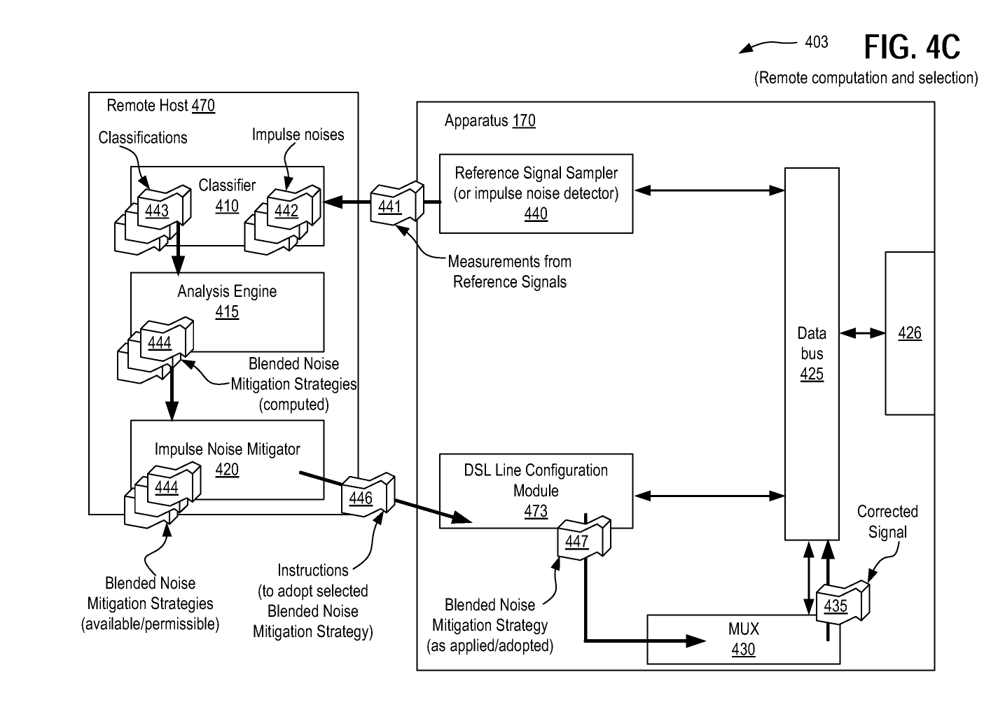

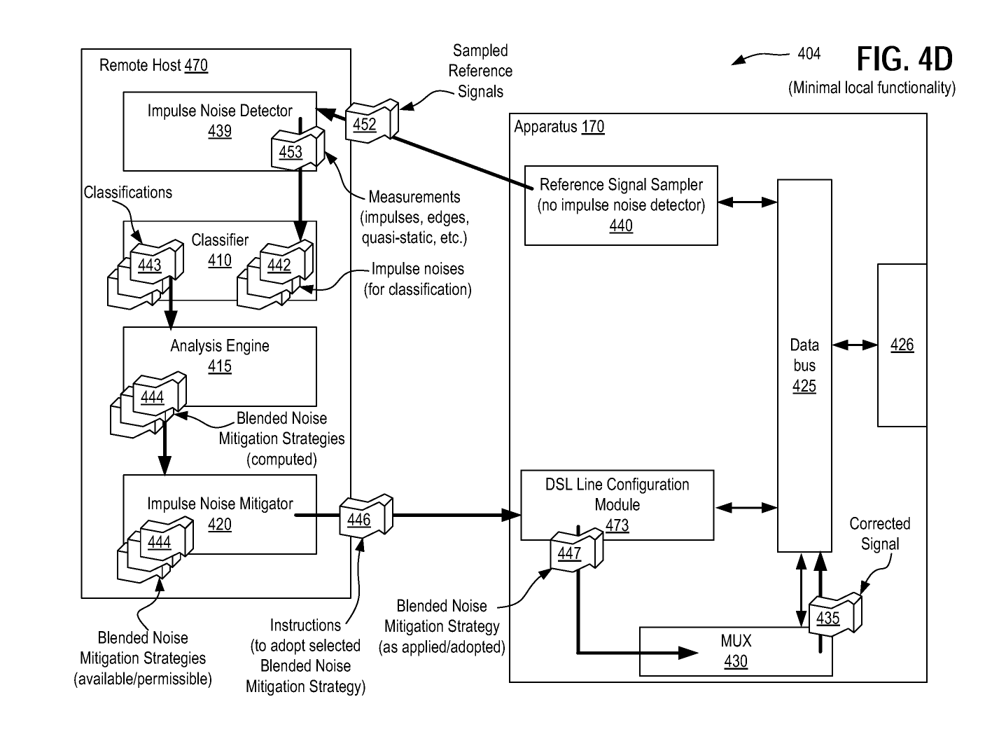

The interference data collected by via interference collector wire 286 and the incoming data from the active DSL loop 294 is converted from analog to digital form by ADC converters 242 which is communicably interfaced to interface 226. The interference noise data is filtered by filter 241, which bases its conditioning of the interference noise on the output of subtractor 240. The received data from loop 294 can be delayed by delay element 243. The conditioned data from loop 294 and interference collector wire 286 is then input to subtractor 240 so that the interference noise can be removed and the remaining user data passed on to the remaining modem components, modules and/or processing 298. The ADC(s) 242, filter 241 subtractor 240 depicted represent exemplary circuitry operable in conjunction with an analysis engine (e.g., see element 320 of FIG. 3, element 415 of FIGS. 4A-4D, et seq.) in accordance with one embodiment.

In certain embodiments, additional interference collector wires can be brought into service using other wires from inactive loops of the multiple loop segment 206. For example, as shown by the dashed connections 254, wires 283, 284, and 285 can similarly be employed as needed. ADC(s) 242 may then be more than just a single converter and may instead be any suitable conversion circuitry, as will be appreciated by those skilled in the art. Similarly, in such a case, filter 241 may be adaptive filtering circuitry, as will be appreciated by those skilled in the art. Finally, multiple wires in the multiple loop segment 206 can be used to remove interference. Such wires may be referred to as “references,” “channels,” “reference channels” or “reference signals,” in accordance with the methods and techniques described herein. In accordance with one embodiment, any of the wires associated with active 294 or the inactive 291, 292, and 293 loops or lines may be utilized to provide extra twisted pair telephone lines and/or interference collector wires for use in canceling interference in more than one telephone line employed as an active DSL line, for example, where such other active DSL lines are bonded and vectored.

Where a DSL system has available to it additional loops or lines for use as interference collector wires, the RF or other noise and/or interference may be canceled in across all the active DSL lines. In the example depicted here, there are 8 wires in the multiple loop segment 206, only two of which are in use, the two used for loop 294. Thus, according to an exemplary embodiment, the other 6 wires may be used as follows: Interference collector wire 286 for collecting RF interference data, and wires 281-285 (all associated with inactive lines) are then used for collecting interference data for the 5 most significant crosstalkers affecting active loop 294. That is, in a system having N telephone loops or lines available, where one of the telephone loops is the active DSL line, one or more wires in the remaining N−1 loops may be utilized as the interference collector wire or interference collection means to collect interference data. Because there are 2 wires in each loop, there are 2(N−1) wires available for collecting interference data affecting the signals received by CPE modem 271 using the active DSL line. Any suitable interference canceling means can be used in connection with the interference collector wire(s), including more than one type of interference canceling structure where more than one type of interference noise is being removed and/or canceled. Each wire can be used to remove a single source of interference noise or impulse noise (for example, AM radio interference, a household appliance near the shared segment 260, crosstalk, etc.). Each wire's corresponding interference data can be converted to digital form and be filtered appropriately.

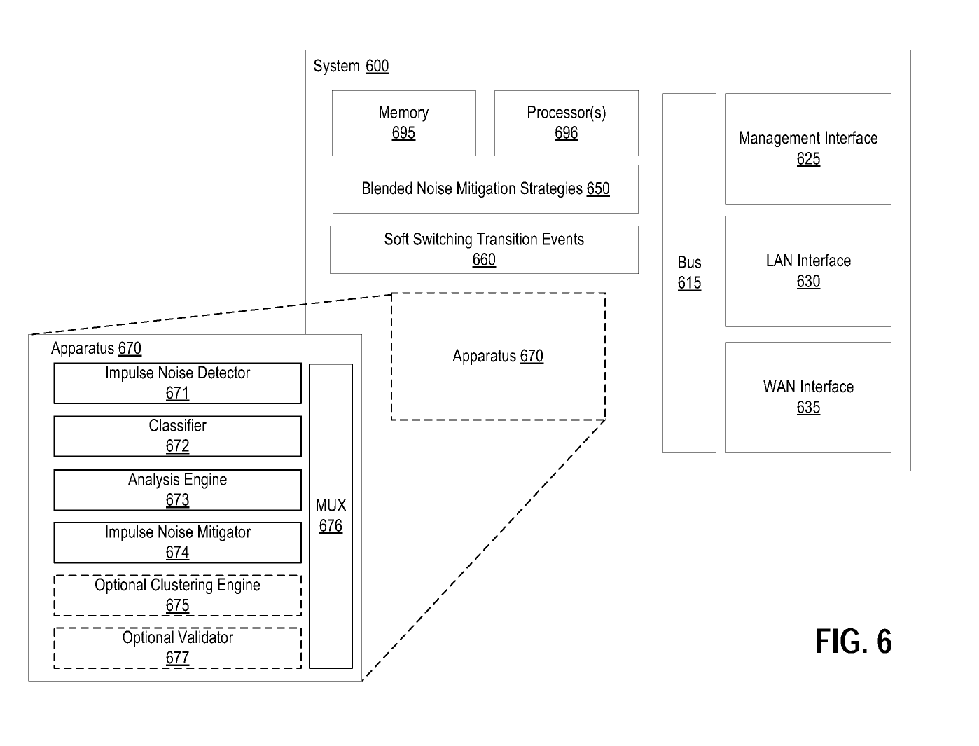

FIG. 3 illustrates an alternative exemplary architecture 300 in accordance with which embodiments may operate. FIG. 3 depicts how multiple classifiers 310 may operate in concert to provide information to an analysis engine (e.g., see element 415 at FIG. 4A, et seq., and element 673 at FIG. 6) which then renders a decision as to which impulse noise classes or previously computed impulse noise mitigation strategies are selected for use with a blended noise mitigation strategy 328. An analysis engine may operate at a remote location, separate from a DSL network component coupled with the DSL line or may operate locally to a network component coupled with the DSL line. For instance, where the analysis engine operates remotely, a local DSL network component may collect waveforms or impulse noise samples which are then communicated to the remote location for analysis by the analysis engine 320.

In accordance with one embodiment, classifiers 301A and 301B are utilized, in which each of the classifiers 301A and 301B includes a delay 310 block and canceller (e.g., a filter) 1 315A through canceller N 315B capable to evaluate reference signals or primary signals 302A and 302B as input.

The noise mitigation strategy database 325 stores a plurality of impulse noise mitigation strategies and also provides classifier configurations 326 to each of the classifiers 301A-B. Analysis engine 320 renders a decision as to which of a plurality of noise mitigation strategies to choose based on input from the classifiers 301A and 301B and based further on cancellation configuration 327 from the noise mitigation strategy database 325.

The analysis engine 320 then outputs the blended noise mitigation strategy 328. In accordance with one embodiment, the apparatus 170 retrieves the plurality of noise mitigation strategies from the noise mitigation strategy database 325 operating as a remote database.

Classification may be based upon cancellation, however, other features or techniques may be utilized such as covariance. For example, using cancellation, noise may be canceled in one of the reference signals 302A-B using noise taken from another reference signal 302A-B. Cancellation may also be implemented using a predictive configuration. With predictive configuration, the reference signals in 302A and 302B are identical. Therefore, the canceller filter (315A-315B) becomes a linear prediction filter. Unlike other configurations, this predictive configuration can test only the autocorrelation of the impulse noise in a particular channel.

In one embodiment, a classification filter is applied one of the signals (either a primary signal or a reference signal) and then the filtered output is subtracted from another signal (either a primary signal or a reference signal). Based on the subtraction, an energy reduction is calculated to determine effectiveness or to grade and rank the relative effectiveness where multiple filters and reference channels are utilized.

In another embodiment, each of a plurality of classification filters represents an impulse class. However, in some embodiments there may be more than one classification filter per impulse class. For example, one classification filter may be used to test-cancel the impulse in common mode by using differential mode such that that input to the classification filter is differential mode and the output is applied to common mode. Another classification filter may then be used to test-cancel the impulse in powerline by using common mode. The test-cancellation results may then be merged, and then classification of the impulse noise event will based on the merged result.

The classifiers 301A-B may apply different solutions, such as multiple short classification filters associated with different available classes, thus producing a variety of results which may later be subject to analysis, validation, grading, and ranking. For example, different solutions may be applied to the available reference channels and then the results may be analyzed to determine whether or not a particular classification filter is appropriate and additionally be graded and ranked so as to determine which of multiple successful classification filters works best. In such embodiments, the higher ranked or higher graded classifications may then be utilized in computing the blended noise mitigation strategy 328.

One means for determining success is to measure the energy output of an output signal. For example, if the energy output of the output signal is less than a corresponding input, then cancellation may have provided some beneficial cancellation on the applicable reference line which could also benefit the primary signal communications on the DSL line. Although the DSL communication channel of the DSL line may itself be evaluated, it is often beneficial to use at least one or more reference channels to perform the classification operation as the reference channels will not be saturated with high energy DSL signals carrying payload data.

Evaluation of the active DSL line may occur by, for example, evaluating a common mode of the DSL line given that the DSL line communicates via differential mode. Thus, where as the DSL communication channel may exhibit a high level of total energy, the common mode on the same physical DSL line may exhibit a significantly lower level of total energy, and is therefore a feasible source detecting and classifying impulse noise.

In one embodiment, one of classifiers 301A-B determines that a cold-start condition exists and the analysis engine 320 responsively identifies a cold-start default class specifying a default filter calculation as the noise mitigation strategy to apply a default filter calculation.

Upon identification of a cold-start condition, a blended noise mitigation strategy may not be available, and thus, the original signal may simply be allowed to pass through or be selected at the MUX, despite the existence of the impulse noise event on the DSL communication signal. Statistics associated with the unknown type of impulse noise event may be gathered and the actual waveform itself may be captured, and then such data is provided to an entity with more resources to work on the problem and update the noise mitigation strategies appropriately. For example, such information may be communicated to a remote server which provides such a service or collected and stored locally by a signal conditional device which implements such a function. Although the immediately encountered impulse noise is not mitigated, over time the collection of such data will nevertheless improve service overall.

Because more than one reference signal may be utilized at the same time, more than one cancellation filter may also be actively used, thus establishing a multi-reference structure in the hardware.

Thus, in accordance with one embodiment, classifying the detected impulse noise includes: (a) applying distinct classification filters to one of a plurality of reference channels, in which each of the distinct classification filters correspond to a different class; (b) grading effectiveness (e.g., via a validator) of each of the distinct classification filters based on a decrease of energy output from each of the plurality of reference channels; and (c) ranking the distinct classification filters based on the grading to establish a classification for the detected impulse noise.

In accordance with one embodiment, a classifier operates using pre-processed signals. In another embodiment, the classifier includes, or is interfaced with, a plurality of receivers communicatively interfaced to a corresponding number of reference channels.

In one embodiment, analysis engine 320 may further coordinate grading and ranking operations also referred to as scorecarding. For instance, where multiple cancellation strategies are identified by the apparatus 170 or multiple various filters are applied to signals accessible to the apparatus 170, each of the plurality of noise mitigation strategy results or filter output may be later evaluated to determine what resulting output should be utilized in computing the blended noise mitigation strategy 328.

In accordance with one embodiment, analysis engine 320 updates a cancellation coefficient for use in computing the blended noise mitigation strategy based on observations of observations at a DSL line subsequent to implementation of an initially computed and applied blended noise mitigation strategy 328.

In accordance with one embodiment, analysis engine 320 determines validity of a blended noise mitigation strategy and a grade or rank for an applied blended noise mitigation strategy based on at least one of the following criteria: (a) validating a corrected signal when a decrease of total energy is exhibited; (b) validating the corrected signal when a decrease of energy in excess of a threshold is exhibited; and (c) validating the corrected signal from among a plurality of corrected signals based on the corrected signal having a greatest energy within a specified frequency band corresponding to transmission of the communications on the DSL line.

FIG. 4A depicts an alternative exemplary architecture 401 using local computation and selection in accordance with which embodiments may operate is depicted. More particularly, architecture 401 implements impulse noise soft switching using a blended noise mitigation strategy which is computed locally by apparatus 170. In other embodiments, as will be shown by the Figures that follow, computation of the blended noise mitigation strategy may be conducted at a remote host on behalf of a local apparatus, such as a DSL network component coupled with a DSL line. Other variations will additionally be described.

According to the exemplary architecture 401 there is an apparatus 170 which is coupled with a DSL line 450 via an interface 426. DSL signals 499 are communicated to and from the apparatus 170 via the DSL line 450 in support of, for example, DSL communication services as provided by a DSL service provider. For example, Internet access for a home or business may be attained through the DSL line 450 and the DSL signals 499 communicated via the DSL line 450.

Various noises affect performance of the DSL line 450 carrying the DSL signals 499; such noises may be static 423, quasi-static 422, or impulsive, referred to in the DSL arts as “impulse noises” 421. Such noises may be observed within the DSL signals 499 but are present amongst data carrying signals, and as such, it may be difficult to differentiate noise signals versus data signals. Accordingly, one or more reference sources 451 may be utilized to collect, measure, monitor, and/or observe one or more reference signals 498 (e.g., any one or more of the static 423, quasi-static 422, and “impulse noises” 421). By collecting the one or more reference signals 498 from references sources which do not carry the DSL signals 499, the noise signals may be more readily differentiated from data carrying signals, which in turn, provides an input upon which noise mitigation may be implemented for the DSL line.

The reference sources 451 themselves may be unused DSL lines coupled with the interface 426, an antenna, channels or frequency ranges of the DSL line 450 that are not used for carrying DSL signals 499, and so forth.

Within apparatus 170, the DSL signals 499 and reference signals 498 (e.g., any one or more of the static 423, quasi-static 422, and “impulse noises” 421) are made available to the various components via data bus 425.

According to one embodiment, apparatus 170 may operate as a DSL network component, such as a CPE modem coupled with the DSL line, a DSL controller within such a modem, a DSL line card interfaced to the DSL line, a signal booster interfaced to a CPE modem coupled with the DSL line, and so forth.

In such an embodiment, the impulse noise detector 405 of apparatus 170 is configure to capture measurements from one or more reference signals 498 received at the DSL network component (e.g., apparatus 170) coupled with the DSL line 450, in which the measurements 424 correspond to impulse noise 421 events occurring at the DSL line 450; classifier 410 then classifies the impulse noise events 421 into a plurality of impulse noise classes 411 (e.g., as derived from the measurements 424 corresponding to the impulse noise events). In such an embodiment, analysis engine 415 computes a blended noise mitigation strategy 433 using one or more of the impulse noise classes 411. As shown here, multiple blended noise mitigation strategies 433 are computed by analysis engine 415, in which case the analysis engine 415 or the impulse noise mitigator 420 may additionally select one of the multiple blended noise mitigation strategies 433 for implementation. Regardless, impulse noise mitigator 420 then applies impulse noise soft switching to the DSL line 450 using the blended noise mitigation strategy 434 computed (and selected when necessary) and the impulse noise mitigator 420 maintains the blended noise mitigation strategy 434 at the DSL line 450 for mitigating the impulse noise events on the DSL line 450.

For instance, as can be seen at the MUX 430, the blended noise mitigation strategy 434 is applied resulting in corrected signal 435 which is then returned to the data bus 425.

In such a way, local computation and selection of a blended noise mitigation strategy is attained.

FIG. 4B illustrates an alternative exemplary architecture 402 using remote computation and local selection in accordance with which embodiments may operate. More particularly, architecture 402 implements impulse noise soft switching using a blended noise mitigation strategy which is computed remotely, such as at a remote host, but selected locally at apparatus 170, for instance, operating as a DSL network component coupled with a DSL line (e.g., see 450 at FIG. 4A) as was described previously.

In such an embodiment, apparatus 170 includes at least a reference signal sampler 440 capable of sampling noises from the reference signals, including impulse noises as previously described, resulting in measurements 441 from the reference signals. Apparatus 170 may optionally include an impulse noise detector which is capable of determining the presence of impulse noises within the measurements 441, but is not required to do so, as the remote host 470 may perform such a function on behalf of the apparatus 170.

According to one embodiment, apparatus 170 captures measurements 441 from one or more reference signals received at the DSL network component (e.g., apparatus 170) coupled with the DSL line 450, in which the measurements 441 correspond to impulse noise events occurring at the DSL line. Such measurements are communicated to a remote host 470 via a network and remote host 470 then determines the impulse noises 442 from the measurements 441 received from the apparatus 170 and classifies the impulse noises 442 determined into a plurality of classifications 443 via the classifier 410 at the remote host 470.

Analysis engine 415 computes a plurality of blended noise mitigation strategies 444 using the classifications 443 of the impulse noises 442 determined. As shown here, multiple blended noise mitigation strategies 444 are computed by analysis engine 415, and these are then communicated back to the impulse noise mitigator 420 of the DSL network component (e.g., apparatus 170) resulting in the impulse noise mitigator 420 having multiple blended noise mitigation strategies 444 available or permissible for use with impulse noise soft switching to mitigate noise on the DSL line.

In such an embodiment, the impulse noise mitigator 420 locally selects, at the DSL network component (e.g., apparatus 170), which one of the multiple blended noise mitigation strategies 444 available is to be applied to the DSL line, and then the selected blended noise mitigation strategy 445 is applied to the DSL line resulting in the corrected signal 435 by the MUX 430 which is then returned to the data bus 425.

In such a way, remote computation and local selection of a blended noise mitigation strategy is attained.

FIG. 4C illustrates an alternative exemplary architecture 403 using remote computation and selection in accordance with which embodiments may operate. More particularly, architecture 403 implements impulse noise soft switching using a blended noise mitigation strategy which is computed remotely and selected remotely, such as at a remote host, and then applied to the DSL line by sending instructions 446 to a DSL line configuration module 473 of a DSL network component (e.g., apparatus 170).

Similar to FIG. 4B, apparatus 170 includes at least a reference signal sampler 440 capable of sampling noises from the reference signals, and may optionally include an impulse noise detector, but is not required to do so.

As is shown here, apparatus 170 captures measurements 441 from one or more reference signals received at the DSL network component (e.g., apparatus 170) coupled with the DSL line 450, in which the measurements 441 correspond to impulse noise events occurring at the DSL line. Such measurements are communicated to remote host 470 via a network and remote host 470 then determines the impulse noises 442 from the measurements 441 received from the apparatus 170 (if not determined locally at apparatus 170). Classifier 410 classifies the impulse noises 442 and analysis engine 415 computes one or more blended noise mitigation strategies 444.

Unlike the prior FIG. 4B, the local DSL network component (e.g., apparatus 170) does not have an impulse noise mitigator, but rather, its role is carried out by the remote host 470 via impulse noise mitigator 420 at the remote host 470 which selects from among the multiple blended noise mitigation strategies 444 available/permissible and then sends instructions 446 to a DSL line configuration module 473 at the local DSL network component (e.g., apparatus 170) coupled with the DSL line, the instructions 446 telling the apparatus 170 to adopt the selected blended noise mitigation strategy. The DSL line configuration module 473 then applies/adopts the blended noise mitigation strategy 447 resulting in the corrected signal 435 by the MUX 430 which is then returned to the data bus 425.

In such a way, remote computation and remote selection of a blended noise mitigation strategy is attained.

FIG. 4D illustrates an alternative exemplary architecture 404 using minimal local functionality in accordance with which embodiments may operate. More particularly, architecture 404 implements impulse noise soft switching using a blended noise mitigation strategy in which a remote host 470 carries out the impulse noise detection, classification, computation, analysis, and selection, and the apparatus 170 with minimal functionality is required only to capture reference signal samples which are communicated to the remote host 470 and apply a blended noise mitigation strategy 447 responsive to instructions 446 from the remote host 470.

The embodiment depicted here is similar to FIG. 4C, except that the local DSL network component (e.g., apparatus 170) does not have an impulse noise detector, and is not required to have one, as the remote host 470 expressly carries out the function of impulse noise detection via its impulse noise detector 439 based on the sampled reference signals 452 communicated to the remote host 470 from apparatus 170. The sampled reference signals 452 are captured by the apparatus 170 via reference signal sampler 440, as described previously.

At the remote host 470, impulse noise detector 439 determines measurements 453 (e.g., impulses, edges before and after an impulse noise event, static noise, quasi-static noise, etc.) and classifier 410 determines a plurality of impulse noises 442 for classification from the measurements 453, resulting in classifications 443. Analysis engine computes one or more blended noise mitigation strategies 444 using the classifications 443 and an impulse noise mitigator 420 at the remote host 470 sends instructions 446 to the DSL network component (e.g., apparatus 170) coupled with the DSL line to apply the blended noise mitigation strategy 447.

A DSL line configuration module 473 at the DSL network component (e.g., apparatus 170) applies/adopts the blended noise mitigation strategy 447 resulting in the corrected signal 435 by the MUX 430 which is then returned to the data bus 425.

In such a way, a DSL network component, such as apparatus 170 having minimal local functionality may nevertheless implement impulse noise soft switching using the blended noise mitigation strategy 447 specified via instructions 446 from the remote host 470.

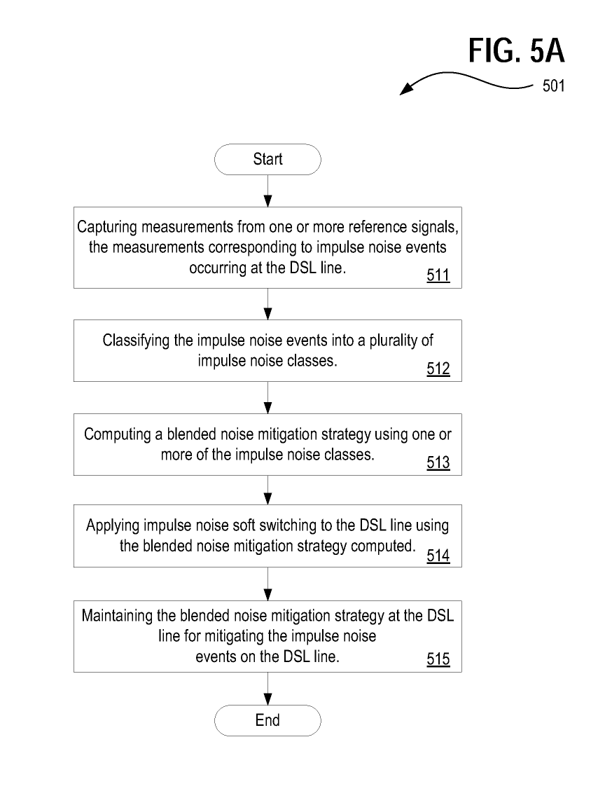

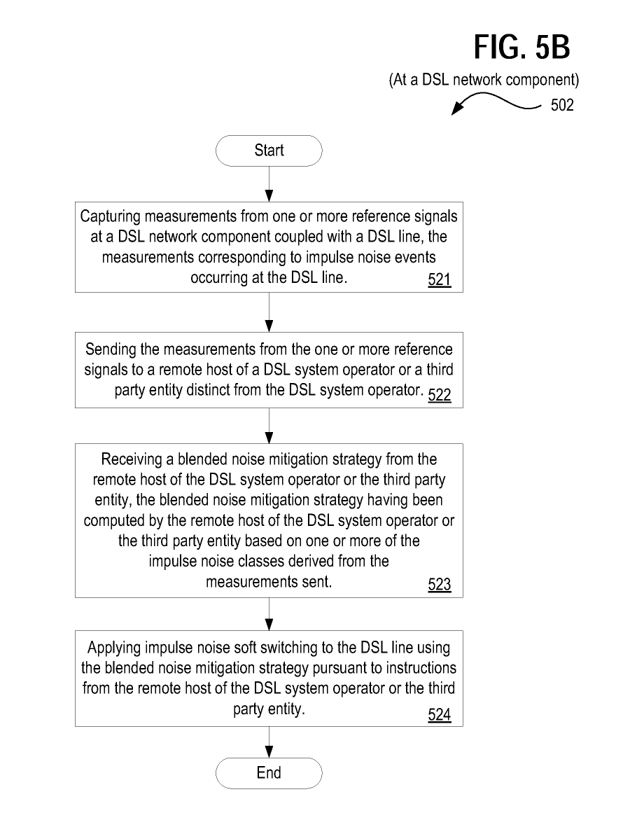

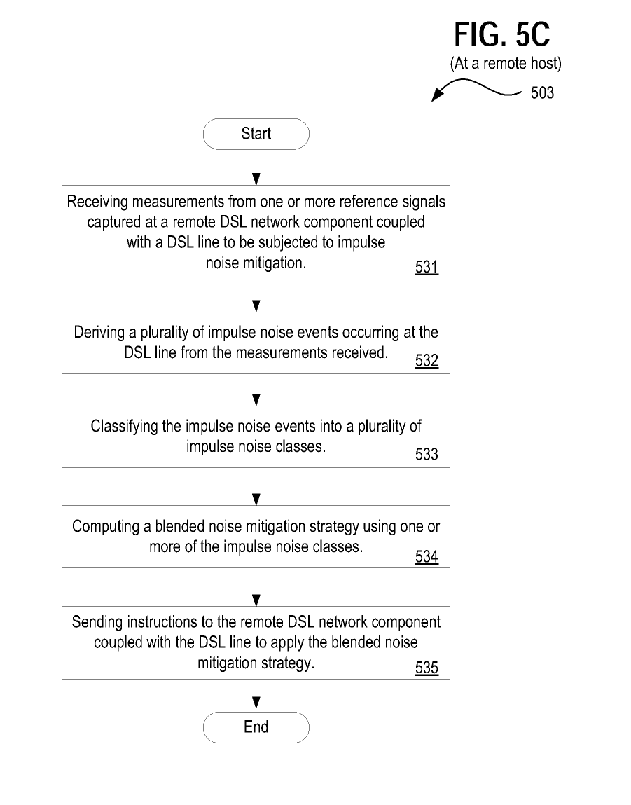

FIG. 5A is a flow diagram illustrating a method 501 for implementing impulse noise mitigation via soft switching in accordance with described embodiments.

FIG. 5B is a flow diagram illustrating a method 502 at a DSL network component for implementing impulse noise mitigation via soft switching in accordance with described embodiments.

FIG. 5C is a flow diagram illustrating a method 503 at a remote host for implementing impulse noise mitigation via soft switching in accordance with described embodiments.

Methods 501, 502, and 503 may be performed by processing logic that may include hardware (e.g., circuitry, dedicated logic, programmable logic, microcode, etc.), software (e.g., instructions run on a processing device to perform various operations such as interfacing, capturing, collecting, receiving, monitoring, analyzing, classifying, computing, applying, maintaining, or some combination thereof). In one embodiment, methods 501, 502, and 503 are performed or coordinated via an apparatus such as that depicted at element 170 of FIG. 1 and described throughout, or may be carried out cooperatively via a remote host and a local apparatus, including the various representations of apparatus 170 and remote host 470 at FIGS. 4B, 4C, and 4D, and and/or apparatus 670 of FIG. 6. Some of the blocks and/or operations listed below are optional in accordance with certain embodiments. The numbering of the blocks presented is for the sake of clarity and is not intended to prescribe an order of operations in which the various blocks must occur. Additionally, operations from methods 501, 502, and 503 may be utilized in a variety of combinations, including in combination with operations from any of the flow diagrams depicted at FIGS. 5A, 5B, and 5C.

Referring now to FIG. 5A, method 501 includes processing logic for capturing measurements from one or more reference signals, the measurements corresponding to impulse noise events occurring at the DSL line (block 511).

At block 512, processing logic classifies the impulse noise events into a plurality of impulse noise classes.

At block 513, processing logic computes a blended noise mitigation strategy using one or more of the impulse noise classes.

At block 514, processing logic applies impulse noise soft switching to the DSL line using the blended noise mitigation strategy computed.

At block 515, processing logic maintains the blended noise mitigation strategy at the DSL line for mitigating the impulse noise events on the DSL line.

According to another embodiment, methods further include: capturing one or more non-impulse noise measurements from the one or more reference signals; and in which computing the blended noise mitigation strategy includes using one or more of the impulse noise classes and one or more of the non-impulse noise measurements captured.

According to another embodiment of the methods described, maintaining the blended noise mitigation strategy at the DSL line includes: applying the impulse noise soft switching to the DSL line using the blended noise mitigation strategy until the occurrence of a soft switching transition event; and applying a new blended noise mitigation strategy upon the occurrence of the soft switching transition event.

According to another embodiment of the methods described, applying the impulse noise soft switching to the DSL line further includes applying a new blended noise mitigation strategy upon the occurrence of a soft switching transition event selected from the group including: (i) a pre-determined period of time expiring for the blended noise mitigation strategy currently in effect; (ii) effectiveness of the blended noise mitigation strategy currently applied being assessed below a threshold; (iii) receiving instructions to apply the new blended noise mitigation strategy; and (iv) operational performance of the DSL line falling below a threshold.

According to another embodiment of the methods described, maintaining the blended noise mitigation strategy at the DSL line includes: maintaining the blended noise mitigation strategy across multiple new impulse noise events occurring at the DSL line, in which the blended noise mitigation strategy remains in effect during periods of impulse noise and during periods without impulse noise.

According to another embodiment of the methods described, a DSL modem coupled with the DSL line or a DSL line optimizer communicatively interfaced with the DSL modem performs the applying impulse noise soft switching to the DSL line and performs the maintaining the blended noise mitigation strategy at the DSL line.

According to another embodiment of the methods described, the DSL modem or the DSL line optimizer receives the blended noise mitigation strategy and responsively applies the impulse noise soft switching to the DSL line.

According to another embodiment of the methods described, a third party service provider performs the classifying of the impulse noise events and performs the computing of the blended noise mitigation strategy; in which applying impulse noise soft switching to the DSL line includes the third party service provider sending the blended noise mitigation strategy to the DSL modem or to a DSL optimizer coupled with the DSL modem with instructions to apply and maintain the DSL the blended noise mitigation strategy at the DSL line using the blended noise mitigation strategy sent; and in which the third party service provider is an entity separate from a DSL service provider responsible for providing DSL communication services to a DSL customer via the DSL line.

For example, a server that operates remotely from a DSL network component coupled with the DSL line establishes a connection to the local DSL network component (e.g., a modem, a signal booster, or other device at a customer premises), the server operating remotely receives measurements or other information representing the impulses on the DSL line for processing, the remote server classifies the impulse noises (and may additionally perform impulse classifying), then computes per-impulse specific mitigation strategies, chooses at least one of the per-impulse specific mitigations strategies (often more) and other noise mitigation data (e.g., cross-talk, static or quasi-static noises, leading/trailing edges of a selected impulse noise event, etc.) as inputs from which a blended noise mitigation strategy is derived, and then sends the blended noise mitigation strategy back to the DSL network component coupled with the DSL line with instructions to implement for at least a period of time.

According to another embodiment of the methods described, a DSL service provider performs the classifying of the impulse noise events and performs the computing of the blended noise mitigation strategy; in which applying impulse noise soft switching to the DSL line includes the DSL service provider sending the blended noise mitigation strategy to the DSL modem coupled with the DSL line or to the DSL network component communicatively interfaced with the DSL modem with instructions to apply and maintain the blended noise mitigation strategy sent. In such an embodiment, the DSL service provider is an entity responsible for providing DSL communication services to a DSL customer via the DSL line.

According to another embodiment of the methods described, computing the blended noise mitigation strategy using one or more of the impulse noise classes, includes one of: computing the blended noise mitigation strategy using two distinct impulse noise classes; or alternatively computing the blended noise mitigation strategy using the one or more impulse noise classes and further using one or more of (i) non-impulse static noise captured from the reference signals, (ii) non-impulse quasi-static noise captured from the reference signals, (iii) a no-impulse noise class, and (iv) non-impulse cross-talk noise captured from the reference signals.

According to another embodiment of the methods described, mitigating noise on the DSL line further includes: applying a narrow band noise canceller to the DSL line in addition to application of the blended noise mitigation strategy applied to the DSL line.

According to another embodiment of the methods described, computing the blended noise mitigation strategy includes a third party service provider or a DSL service provider computing multiple different blended noise mitigation strategies using a plurality of impulse noise classes based on the impulse noise events classified; sending the multiple different blended noise mitigation strategies to a DSL network component communicatively interfaced with the DSL line with instructions to implement the impulse noise soft switching at the DSL line; and in which the DSL network component locally selects which one among the multiple different blended noise mitigation strategies sent to apply to the DSL line for mitigating the impulse noise events on the DSL line.

According to another embodiment of the methods described, computing the blended noise mitigation strategy includes computing the blended noise mitigation strategy comprises determining a determining correlation functions for each of the impulse noise classes; and computing the blended noise mitigation strategy from two or more of the covariance matrices.

In such a way, the blended noise mitigation strategy may yield a compromise solution that is less good than a per-impulse solution idealized for either the first or the second impulse noise classes, but which may nevertheless be applied in an impulse noise agnostic manner so as to accommodate potentially more impulse noises without having to detect and switch the solution in and out on a per-impulse noise basis. In other words, the blended noise mitigation strategy may remain in effect during periods that are void of impulse noises on the DSL line, where as a per-impulse noise solution, would not be appropriate to remain in effect during periods that are void of impulse noise events on the DSL line.

According to another embodiment, methods further include: ranking the plurality of impulse noise classes based on an estimated negative impact each impulse noise class imposes upon the DSL line; and selecting one or more of the highest ranked impulse noise classes for use in computing the blended noise mitigation strategy.

According to another embodiment, methods further include: estimating a negative impact to the DSL line for each of the plurality of impulse noise classes by comparing scaling DMT margin and a geometric average of noise enhancement due to the impulse noise event corresponding to the impulse noise class, in which the noise enhancement is due to the increase of noise variance due to the impulse noise in DSL downstream tones used for communication on the DSL line.

According to another embodiment, methods further include: estimating a negative impact to the DSL line for each of the plurality of impulse noise classes by comparing an Impulse Noise Protection (INP) setting of Forward Error Correction (FEC) for the DSL line with the number of Discrete Multi-Tone (DMT) symbols affected by the impulse noise event corresponding to the impulse noise class within the latency of the FEC for the DSL line.

According to another embodiment of the methods described, the INP and FEC are learned via a communications interface to a DSL modem coupled with the DSL line or a DSL network component communicatively interfaced with the DSL modem; and in which the number of DMT symbols affected by the impulse noise event are learned based on an estimated periodicity of an impulse type which constitutes the impulse noise event using symbol boundary determination.

According to another embodiment, methods further include: estimating a negative impact to the DSL line for each of the plurality of impulse noise classes by correlating Cyclic Redundancy Check (CRC) error stats and/or Forward Error Correction (FEC) counts obtained when the impulse noise event corresponding to the impulse noise class occurs at the DSL line; and in which the CRC error stats and/or the FEC counts are learned via a communications interface to a DSL modem coupled with the DSL line or a DSL network component communicatively interfaced with the DSL modem.

According to another embodiment, methods further include: estimating a negative impact to the DSL line for each of the plurality of impulse noise classes by one or more of the following criteria: (i) frequency of occurrence on the DSL line for the respective impulse noise class; (ii) duration of high power noise over a threshold on the DSL line for the respective impulse noise class; (iii) probability of occurrence of the respective impulse noise class on the DSL line; and (iv) spectral content corresponding to the respective impulse noise class overlapping into frequency bands utilized by the DSL line for carrying DSL communication signals.

According to another embodiment, methods further include: receiving pre-mitigation operational data for the DSL line before the blended noise mitigation strategy is applied to the DSL line; receiving post-mitigation operational data for the DSL line after the blended noise mitigation strategy is applied to the DSL line by the DSL network component; and evaluating performance of the blended noise mitigation strategy applied to the DSL line based on a comparison of the pre-mitigation operational data and the post-mitigation operational data.

According to another embodiment of the methods described, the pre-migration operational data and the post-migration operational data includes one or more of: downstream Cyclic Redundancy Check (CRC) error stats; downstream Forward Error Correction (FEC) counts; Forward Error Correction (FEC) configuration and Impulse Noise Protection (INP) delay settings for the DSL line; margin for the DSL line; and downstream Maximum Attainable Bit Rate (MABR) for the DSL line.

According to another embodiment of the methods described, the pre-migration operational data and the post-migration operational data is determined according to one of: reporting from a Digital Subscriber Line Access Multiplexer (DSLAM) communicatively interfaced with the DSL line; reporting from a Customer Premises Equipment (CPE) modem communicatively interfaced with the DSL line; and derived from impulse noise statistics.

According to another embodiment, methods further include: computing the blended noise mitigation strategy using two or more of the impulse noise classes; weighting each of the two or more of the impulse noise classes to be used in computing the blended noise mitigation strategy; and in which computing the blended noise mitigation strategy from the two or more of the impulse noise classes includes emphasizing the impulse noise classes in the blended noise mitigation strategy having a greatest weighting over all other impulse noise classes among the two or more impulse noise classes having a lesser weighting.

According to another embodiment of the methods described, the measurements corresponding to impulse noise events occurring at the DSL line includes: impulse noise data between a leading edge and a trailing edge for each of the respective impulse noises; rise and fall rates for the leading and trailing edges for each of the respective impulse noises; leading margin data preceding the leading edge for each of the respective impulse noises; and trailing margin data following the trailing edge for each of the respective impulse noises.

According to another embodiment of the methods described, the measurements corresponding to impulse noise events occurring at the DSL line includes for each respective impulse noise event: a DSL signal sample recorded from the DSL line for a period of time inclusive of: (i) a signal portion recorded in advance of the impulse noise on the DSL line; (ii) a signal portion recorded for the duration of the impulse noise on the DSL line; and (iii) a signal portion recorded after the impulse noise on the DSL line.

According to another embodiment of the methods described, computing the blended noise mitigation strategy includes: computing the blended noise mitigation strategy based on at least the signal portions (i), (ii), and (iii) for each of the respective one or more impulse noise classes used.

According to another embodiment of the methods described, computing the blended noise mitigation strategy includes using one or more of the impulse noise classes and further using one or more non-impulse noise measurements captured at the DSL line; and in which computing the blended noise mitigation strategy further includes, for each of the one or more impulse noise classes used and for each of the one or more of the non-impulse noise measurements used: (a) identifying a first frequency band in which noise cancellation is not required, (b) identifying a second frequency band in which there are known un-correlated noise sources, (c) creating a first covariance matrix which has large power in each of the first and the second frequency bands identified, and (d) calculating the blended noise mitigation strategy as a filter coefficient from at least the signal portions (i), (ii), and (iii) for each of the respective one or more impulse noise classes used and calculating the blended noise mitigation strategy based further on the first covariance matrix created at (c) having the large power in each of the first and the second frequency bands identified.

According to another embodiment of the methods described, computing the blended noise mitigation strategy further includes using the one or more reference signals in the computation; in which, for each of the one or more reference signals used, the computing the blended further includes: (a) identifying correlated noise with a primary signal, and (b) computing a power of un-correlated reference noise using correlated noise information from at least the signal portions in (i) and (iii) for each of the respective one or more impulse noise classes used as a filter coefficient by weighting the one or more reference signals using the un-correlated noise power in (ii).

For instance regularization may be included with computing the blended noise mitigation strategy using at least one of the impulse noise classes and at least one non-impulse noise measurement captured. With regard to scaling, the filter may be found by finding correlated noise with a primary signal and then calculating a residual power after application of the found filter by calculating an uncorrelated reference power.

According to another embodiment of the methods described, computing the blended noise mitigation strategy includes using two or more of the impulse noise classes; and in which computing the blended noise mitigation strategy further includes, for each of the two or more impulse noise classes used: (i) identifying the impulse noise signal in the measurement between a leading edge and a trailing edge, (ii) identifying a trailing signal portion in the measurement following the trailing edge of the impulse noise signal, (iii) identifying a leading signal portion greater in length than the trailing signal portion identified, the leading signal portion preceding the leading edge of the impulse noise signal, (iv) calculating a first covariance matrix for each of the two or more impulse noise classes from the leading signal portion, the impulse noise signal, and the trailing edge portion for a first impulse in the measurements corresponding to the first of the two or more impulse noise classes, (v) calculating a second covariance matrix for a second of the two or more impulse noise classes from the leading signal portion, the impulse noise signal, and the trailing edge portion for a second impulse in the measurements corresponding to the second of the two or more impulse noise classes, and (vi) calculating the blended noise mitigation strategy as a filter coefficient from the first and the second covariance matrices.

According to another embodiment of the methods described, the measurements captured from the one or more reference signals are captured at a first DSL network component coupled with the first DSL line and further in which applying the impulse noise soft switching includes instructing the first DSL network component coupled with the first DSL line to adopt the blended noise mitigation strategy computed based on clustering information derived from the measurements captured at the first DSL network component coupled with the first DSL line. In such an embodiment, the method further includes passing the clustering information derived from the measurements captured at the first DSL network component to a second DSL network component coupled with a second DSL line, and in which the second network component is to adopt a second blended noise mitigation strategy computed based at least in part on the clustering information derived from the measurements captured at the first DSL network component.

According to one embodiment, the first and the second DSL network components for which the clustering information is shared are each separated by a geographic distance less than a threshold or determined to reside within a common geographical neighborhood.

According to another embodiment of the methods described, the second blended noise mitigation strategy is computed based on the clustering information shared and based further on channel phases and gains specific to the second DSL line and distinct from channel phases and gains specific to the first DSL line. In such a way, the second DSL line may benefit from the clustering information and statistics without having to re-incur the processing burden to create them, as such workload has already been accomplished for the first DSL network component.

For instance, in such an embodiment, the second DSL line may operate to obtain measurements specific to the second DSL line which may then be utilized to compute the blended noise mitigation strategy with channel phases and gain requirements for the second DSL line. In the context of noise cancellation, filter coefficients for each of the first and the second DSL lines depend upon (i) channel from noise source to the respective DSL line and (ii) channel from noise source to reference channels for the respective DSL line. The phase and gain of the channels for distinct DSL lines servicing different locations are particular to each of the respective DSL lines, even if the different locations are very near to one another.

Therefore, where distinct DSL line locations are in close proximity to one another (e.g., the first and second DSL lines servicing neighboring homes or sharing a common binder), they are likely to be affected by the same impulse noise sources, and thus, may benefit from clustering information of a nearby location, yet the first and second DSL lines servicing the distinct DSL locations will nevertheless each require their own unique filter coefficient. In particular, a second DSL line provided with a priori clustering information from a first DSL line will nevertheless require a filter coefficient that accounts for (i) channel from noise source to the second DSL line and (ii) channel from noise source to reference channels for the second DSL line, regardless of any coefficient determined specific to the first DSL line. Although two DSL lines are described according to this example, more than two such DSL lines may benefit from the same a priori clustering information determined for a first DSL line when such additional lines are within close proximity to the first DSL line.

According to another embodiment of the methods described, applying the impulse noise soft switching to the DSL line using the blended noise mitigation strategy computed includes sending the instructions to adopt the blended noise mitigation strategy to one of: a chipset of a Customer Premises Equipment (CPE) modem communicably interfaced with a first end of the DSL line; a chipset of a signal conditioning device physically separate and distinct from a Customer Premises Equipment (CPE) modem, in which the CPE modem is communicably interfaced with the first end of the DSL line and in which the signal conditioning device is communicatively interfaced to the CPE modem; a controller card configured within a Customer Premises Equipment (CPE) modem communicably interfaced with the first end of the DSL line; and a controller card configured within a signal conditioning device physically separate and distinct from a Customer Premises Equipment (CPE) modem, in which the CPE modem is communicably interfaced with the first end of the DSL line and in which the signal conditioning device is communicatively interfaced to the CPE modem.

In accordance with one embodiment, there is a non-transitory computer readable storage media having instructions stored thereon that, when executed by a processor, the instructions cause the processor to perform operations for mitigating noise on a Digital Subscriber Line (DSL line), the operations including: capturing measurements from one or more reference signals, the measurements corresponding to impulse noise events occurring at the DSL line; classifying the impulse noise events into a plurality of impulse noise classes; computing a blended noise mitigation strategy using one or more of the impulse noise classes; applying impulse noise soft switching to the DSL line using the blended noise mitigation strategy computed; and maintaining the blended noise mitigation strategy at the DSL line for mitigating the impulse noise events on the DSL line.

Referring now to FIG. 5B, method 502 includes processing logic for capturing measurements from one or more reference signals at a DSL network component coupled with a DSL line, the measurements corresponding to impulse noise events occurring at the DSL line (block 521).

At block 522, processing logic sends the measurements from the one or more reference signals to a remote host of a DSL system operator or a third party entity distinct from the DSL system operator.

At block 523, processing logic receives a blended noise mitigation strategy from the remote host of the DSL system operator or the third party entity, the blended noise mitigation strategy having been computed by the remote host of the DSL system operator or the third party entity based on one or more of the impulse noise classes derived from the measurements sent.

At block 524, processing logic applies impulse noise soft switching to the DSL line using the blended noise mitigation strategy pursuant to instructions from the remote host of the DSL system operator or the third party entity.

In accordance with one embodiment, there is a non-transitory computer readable storage medium having instructions stored thereon that, when executed by a processor of an apparatus, the instructions cause the apparatus to perform operations including: capturing measurements from one or more reference signals at a DSL network component coupled with a DSL line, the measurements corresponding to impulse noise events occurring at the DSL line; sending the measurements from the one or more reference signals to a remote host of a DSL system operator or a third party entity distinct from the DSL system operator; receiving a blended noise mitigation strategy from the remote host of the DSL system operator or the third party entity, the blended noise mitigation strategy having been computed by the remote host of the DSL system operator or the third party entity based on one or more of the impulse noise classes derived from the measurements sent; and applying impulse noise soft switching to the DSL line using the blended noise mitigation strategy pursuant to instructions from the remote host of the DSL system operator or the third party entity.

Referring now to FIG. 5C, method 503 includes processing logic for receiving measurements from one or more reference signals captured at a remote DSL network component coupled with a DSL line to be subjected to impulse noise mitigation (block 531).

At block 532, processing logic derives a plurality of impulse noise events occurring at the DSL line from the measurements received.

At block 533, processing logic classifies the impulse noise events into a plurality of impulse noise classes.

At block 534, processing logic computes a blended noise mitigation strategy using one or more of the impulse noise classes.

At block 535, processing logic sends instructions to the remote DSL network component coupled with the DSL line to apply the blended noise mitigation strategy.

In accordance with one embodiment, there is a non-transitory computer readable storage medium having instructions stored thereon that, when executed by a processor of an apparatus, the instructions cause the apparatus to perform operations including: receiving measurements from one or more reference signals captured at a remote DSL network component coupled with a DSL line to be subjected to impulse noise mitigation; deriving a plurality of impulse noise events occurring at the DSL line from the measurements received; classifying the impulse noise events into a plurality of impulse noise classes; computing a blended noise mitigation strategy using one or more of the impulse noise classes; and sending instructions to the remote DSL network component coupled with the DSL line to apply the blended noise mitigation strategy.

FIG. 6 shows an alternative diagrammatic representation of a system 600 in accordance with which embodiments may operate, be installed, integrated, or configured.

In one embodiment, system 600 includes a memory 695 and a processor or processors 696. For example, memory 695 may store instructions to be executed and processor(s) 696 may execute such instructions. Processor(s) 696 may also implement or execute implementing logic capable to implement the methodologies discussed herein. System 600 includes communication bus(es) 615 to transfer transactions, instructions, requests, and data within system 600 among a plurality of peripheral devices communicably interfaced with one or more communication buses 615. System 600 further includes management interface 625, for example, to receive requests, return responses, and otherwise interface with network elements located separately from system 600. System may operate as a DSL network component local to, and coupled with a DSL line, or may operate as a system at a DSL services provider or at third party entity distinct from the DSL services provider, or variants of system 600 may operate cooperatively, for instance, with one variant operating as a local DSL network component coupled with a DSL line and with another variant operating as a system at a DSL service provider or third party entity, each configured to cooperatively carryout the implementation of impulse noise soft switching using a blended noise mitigation strategy.

In some embodiments, management interface 625 communicates information via an in-band or an out-of-band connection separate from LAN and/or WAN based communications. The “in-band” communications are communications that traverse the same communication means as payload data (e.g., content) being exchanged between networked devices and the “out-of-band” communications are communications that traverse an isolated communication means, separate from the mechanism for communicating the payload data. An out-of-band connection may serve as a redundant or backup interface over which to communicate control data and instructions between the system 600 other networked devices or between the system 600 and a third party service provider. System 600 includes LAN interface 630 and WAN interface 635 to communicate information via LAN and WAN based connections respectively. System 600 includes soft switching transition events 660 to determine when a blended noise mitigation strategy currently in effect should be transitioned to a new and different blended noise mitigation strategy, either as selected locally or as instructed by a remote host. Historical information may also be stored and analyzed or referenced when conducting long term analysis and reporting in order to further improve transitions between blended noise mitigation strategies. At element 650, multiple blended noise mitigation strategies are stored or potentially the termination of soft switching and re-instatement of per-impulse mitigation techniques when necessary.

Distinct within system 600 is apparatus 670 which includes impulse noise detector 671, classifier 672, analysis engine 673, impulse noise mitigator 674, and MUX 676. Apparatus 670 may be installed and configured in a compatible system 600 as is depicted by FIG. 6, or embodied in various forms such as a controller, chip set, CPE modem, signal booster, signal conditioning device, etc.

According to a particular embodiment, there is a system 600 for mitigating noise on a Digital Subscriber Line (DSL line), having at least a processor 696 and a memory 695 therein, capable of carrying out instructions on behalf of the system 600. In such an embodiment, the system 600 further includes an impulse noise detector 671 to capture measurements from one or more reference signals, in which the measurements correspond to impulse noise events occurring at the DSL line; a classifier 672 to classify the impulse noise events into a plurality of impulse noise classes; an analysis engine 673 to determine a blended noise mitigation strategy using one or more of the impulse noise classes; an impulse noise mitigator 674 to apply impulse noise soft switching to the DSL line using the blended noise mitigation strategy determined; and further in which the impulse noise mitigator 674 is to maintain the blended noise mitigation strategy at the DSL line for mitigating the impulse noise events on the DSL line. A MUX 676 may apply the blended noise mitigation strategy to a DSL signal resulting in a corrected signal.

The impulse noise detector 671, classifier 672, analysis engine 673, and impulse noise mitigator 674 of the system 600 may reside upon an apparatus 670 to be installed into such a system 600, for instance as a controller, or may be directly configured within the system 600.

According to another embodiment, such a system 600 is to operate at one of: a DSL service provider responsible for providing DSL communication services to a DSL customer via the DSL line, in which the DSL service provider is to communicate with a DSL network component coupled with the DSL line via a management interface of the DSL network component; or in which the system 600 is to operate as a third party service provider, with the system 600 operating as a separate entity from the DSL service provider, and in which the third party service provider is to communicate with the DSL network component coupled with the DSL line via a management interface of the DSL network component. For instance, such a third party provider may operate as a cloud based services provider or a cloud services provider which provides access to functionality and services to subscribers via a public Internet in exchange for a subscription fee.

According to another embodiment, such a system 600 is embodied within a DSL network component selected from the group including: a chipset of a Customer Premises Equipment (CPE) modem communicably interfaced with a first end of the DSL line; a chipset of a signal conditioning device physically separate and distinct from a Customer Premises Equipment (CPE) modem, in which the CPE modem is communicably interfaced with the first end of the DSL line and in which the signal conditioning device is communicatively interfaced to the CPE modem; a controller card configured within a Customer Premises Equipment (CPE) modem communicably interfaced with the first end of the DSL line; and a controller card configured within a signal conditioning device physically separate and distinct from a Customer Premises Equipment (CPE) modem, in which the CPE modem is communicably interfaced with the first end of the DSL line and in which the signal conditioning device is communicatively interfaced to the CPE modem.

According to another embodiment, such a system 600 further includes a management interface to communicatively link the system 600 operating as a DSL network component with a DSL service provider responsible for providing DSL communication services to a DSL customer via the DSL line or to communicatively link the system 600 operating as a DSL network component with a third party service provider operating as a separate entity from the DSL service provider. In such an embodiment, the analysis engine 673 of the system 600 is to determine the blended noise mitigation strategy using one or more of the impulse noise classes by receiving the blended noise mitigation strategy from the DSL service provider or the third party service provider via the management interface and in which the impulse noise mitigator 674 is to apply and maintain the blended noise mitigation strategy at the DSL line responsive to instructions for mitigating the impulse noise events on the DSL line received from the DSL service provider or the third party service provider.

According to another embodiment of system 600, the blended noise mitigation strategy is to be computed by the DSL service provider or computed by the third party service provider based on the measurements from the one or more reference signals captured by the DSL network component and transmitted to the DSL service provider or the third party service provider via the management interface.

According to an alternative embodiment, there is a system 600 for mitigating noise on a Digital Subscriber Line (DSL line), having at least a processor 696 and a memory 695 therein, capable of carrying out instructions on behalf of the system 600, in which the system includes an apparatus 170 coupled with a first end of a Digital Subscriber Line (DSL line), the apparatus having therein an impulse noise detector 671 to detect impulse noise; a classifier 672 to classify the detected impulse noise into one of a plurality of impulse noise classes affecting communications on a Digital Subscriber Line (DSL line); a selection engine to select a blended noise mitigation strategy from among a plurality of blended noise mitigation strategies (e.g., selection may be carried out by analysis engine 673 or impulse noise mitigator 674 or implemented as a separate selection engine component). Such an alternative system 600 further includes an impulse noise mitigator 674 to apply the selected blended noise mitigation strategy; and an optional validator 677 which is to validate application of the noise mitigation strategy (e.g., based on conditions observed on a functioning DSL line having been subjected to a blended noise mitigation strategy). In one embodiment, such a system 600 further includes an optional clustering engine 675 to (i) receive characteristics extracted from each of the observed impulse noises from the apparatus 170, (ii) cluster previously observed impulse noises into groups based at least in part on the characteristics extracted from each of the observed impulse noises received by the clustering engine, (iii) compute the plurality of noise mitigation strategies from the groups of the previously observed impulse noises, pursuant to which classifier 672 is to (i) classify observed impulse noise events into a plurality of impulse noise classes based on the prior clustering, and (ii) provide the plurality of noise mitigation strategies to an analysis engine 673 of the apparatus 170. In such an embodiment, it is not necessary to detect any impulse to engage mitigation, however, measurement capture may be triggered by an impulse detector for the sake of clustering and classification.

While the subject matter disclosed herein has been described by way of example and in terms of the specific embodiments, it is to be understood that the claimed embodiments are not limited to the explicitly enumerated embodiments disclosed. To the contrary, the disclosure is intended to cover various modifications and similar arrangements as would be apparent to those skilled in the art. Therefore, the scope of the appended claims should be accorded the broadest interpretation so as to encompass all such modifications and similar arrangements. It is to be understood that the above description is intended to be illustrative, and not restrictive. Many other embodiments will be apparent to those of skill in the art upon reading and understanding the above description. The scope of the disclosed subject matter is therefore to be determined in reference to the appended claims, along with the full scope of equivalents to which such claims are entitled.

What is claimed is:

1. A method of mitigating noise on a Digital Subscriber Line (DSL line), the method comprising:
capturing measurements from one or more reference signals, the measurements corresponding to impulse noise events occurring at the DSL line;
classifying the impulse noise events into a plurality of impulse noise classes;
computing a blended noise mitigation strategy using one or more of the impulse noise classes;
applying impulse noise soft switching to the DSL line using the blended noise mitigation strategy computed; and
maintaining the blended noise mitigation strategy at the DSL line for mitigating the impulse noise events on the DSL line.

2. The method of claim 1, further comprising:
capturing one or more non-impulse noise measurements from the one or more reference signals; and
wherein computing the blended noise mitigation strategy comprises using one or more of the impulse noise classes and one or more of the non-impulse noise measurements captured.

3. The method of claim 1, wherein maintaining the blended noise mitigation strategy at the DSL line comprises:
applying the impulse noise soft switching to the DSL line using the blended noise mitigation strategy until the occurrence of a soft switching transition event; and
applying a new blended noise mitigation strategy upon the occurrence of the soft switching transition event.

4. The method of claim 1, wherein applying the impulse noise soft switching to the DSL line further comprises applying a new blended noise mitigation strategy upon the occurrence of a soft switching transition event selected from the group comprising:
(i) a pre-determined period of time expiring for the blended noise mitigation strategy currently in effect;
(ii) effectiveness of the blended noise mitigation strategy currently applied being assessed below a threshold;
(iii) receiving instructions to apply the new blended noise mitigation strategy; and
(iv) operational performance of the DSL line falling below a threshold.

5. The method of claim 1, wherein maintaining the blended noise mitigation strategy at the DSL line comprises:
maintaining the blended noise mitigation strategy across multiple new impulse noise events occurring at the DSL line, wherein the blended noise mitigation strategy remains in effect during periods of impulse noise and during periods without impulse noise.

6. The method of claim 1, wherein a DSL modem coupled with the DSL line or a DSL line optimizer communicatively interfaced with the DSL modem performs the applying impulse noise soft switching to the DSL line and performs the maintaining the blended noise mitigation strategy at the DSL line.

7. The method of claim 6, wherein the DSL modem or the DSL line optimizer receives the blended noise mitigation strategy and responsively applies the impulse noise soft switching to the DSL line.

8. The method of claim 1:
wherein a third party service provider performs the classifying of the impulse noise events and performs the computing of the blended noise mitigation strategy;
wherein applying impulse noise soft switching to the DSL line comprises the third party service provider sending the blended noise mitigation strategy to the DSL modem or to a DSL optimizer coupled with the DSL modem with instructions to apply and maintain the DSL the blended noise mitigation strategy at the DSL line using the blended noise mitigation strategy sent; and
wherein the third party service provider is an entity separate from a DSL service provider responsible for providing DSL communication services to a DSL customer via the DSL line.

9. The method of claim 1:
wherein a DSL service provider performs the classifying of the impulse noise events and performs the computing of the blended noise mitigation strategy;
wherein applying impulse noise soft switching to the DSL line comprises the DSL service provider sending the blended noise mitigation strategy to the DSL modem coupled with the DSL line or to the DSL network component communicatively interfaced with the DSL modem with instructions to apply and maintain the blended noise mitigation strategy sent; and
wherein the DSL service provider is an entity responsible for providing DSL communication services to a DSL customer via the DSL line.

10. The method of claim 1, wherein computing the blended noise mitigation strategy using one or more of the impulse noise classes, comprises one of:
computing the blended noise mitigation strategy using two distinct impulse noise classes;
computing the blended noise mitigation strategy using the one or more impulse noise classes and further using one or more of (i) non-impulse static noise captured from the reference signals, (ii) non-impulse quasi-static noise captured from the reference signals, (iii) a no-impulse noise class, and (iv) non-impulse cross-talk noise captured from the reference signals.

11. The method of claim 1, wherein mitigating noise on the DSL line further comprises: applying a narrow band noise canceller to the DSL line in addition to application of the blended noise mitigation strategy applied to the DSL line.

12. The method of claim 1:
wherein computing the blended noise mitigation strategy comprises a third party service provider or a DSL service provider computing multiple different blended noise mitigation strategies using a plurality of impulse noise classes based on the impulse noise events classified;
sending the multiple different blended noise mitigation strategies to a DSL network component communicatively interfaced with the DSL line with instructions to implement the impulse noise soft switching at the DSL line; and
wherein the DSL network component locally selects which one among the multiple different blended noise mitigation strategies sent to apply to the DSL line for mitigating the impulse noise events on the DSL line.

13. The method of claim 1:
wherein computing the blended noise mitigation strategy comprises determining a determining correlation functions for each of the impulse noise classes; and
computing the blended noise mitigation strategy from two or more of the covariance matrices.

14. The method of claim 1, further comprising:
ranking the plurality of impulse noise classes based on an estimated negative impact each impulse noise class imposes upon the DSL line; and
selecting one or more of the highest ranked impulse noise classes for use in computing the blended noise mitigation strategy.

15. The method of claim 1, further comprising:
estimating a negative impact to the DSL line for each of the plurality of impulse noise classes by comparing scaling DMT margin and a geometric average of noise enhancement due to the impulse noise event corresponding to the impulse noise class, wherein the noise enhancement is due to the increase of noise variance due to the impulse noise in DSL downstream tones used for communication on the DSL line.

16. The method of claim 1, further comprising:
estimating a negative impact to the DSL line for each of the plurality of impulse noise classes by comparing an Impulse Noise Protection (INP) setting of Forward Error Correction (FEC) for the DSL line with the number of Discrete Multi-Tone (DMT) symbols affected by the impulse noise event corresponding to the impulse noise class within the latency of the FEC for the DSL line.

17. The method of claim 16:
wherein the INP and FEC are learned via a communications interface to a DSL modem coupled with the DSL line or a DSL network component communicatively interfaced with the DSL modem; and
wherein the number of DMT symbols affected by the impulse noise event are learned based on an estimated periodicity of an impulse type which constitutes the impulse noise event using symbol boundary determination.

18. The method of claim 1, further comprising:
estimating a negative impact to the DSL line for each of the plurality of impulse noise classes by correlating Cyclic Redundancy Check (CRC) error stats and/or Forward Error Correction (FEC) counts obtained when the impulse noise event corresponding to the impulse noise class occurred at the DSL line; and
wherein the CRC error stats and/or the FEC counts are learned via a communications interface to a DSL modem coupled with the DSL line or a DSL network component communicatively interfaced with the DSL modem.

19. The method of claim 1, further comprising:
estimating a negative impact to the DSL line for each of the plurality of impulse noise classes by one or more of the following criteria:
(i) frequency of occurrence on the DSL line for the respective impulse noise class;
(ii) duration of high power noise over a threshold on the DSL line for the respective impulse noise class;
(iii) probability of occurrence of the respective impulse noise class on the DSL line; and
(iv) spectral content corresponding to the respective impulse noise class overlapping into frequency bands utilized by the DSL line for carrying DSL communication signals.

20. The method of claim 1, further comprising:
receiving pre-mitigation operational data for the DSL line before the blended noise mitigation strategy is applied to the DSL line;
receiving post-mitigation operational data for the DSL line after the blended noise mitigation strategy is applied to the DSL line by the DSL network component; and
evaluating performance of the blended noise mitigation strategy applied to the DSL line based on a comparison of the pre-mitigation operational data and the post-mitigation operational data.

21. The method of claim 20, wherein the pre-migration operational data and the post-migration operational data includes one or more of:
downstream Cyclic Redundancy Check (CRC) error stats;
downstream Forward Error Correction (FEC) counts;
Forward Error Correction (FEC) configuration and Impulse Noise Protection (INP) delay settings for the DSL line;
margin for the DSL line; and
downstream Maximum Attainable Bit Rate (MABR) for the DSL line.

22. The method of claim 21, wherein the pre-migration operational data and the post-migration operational data is determined according to one of:
reporting from a Digital Subscriber Line Access Multiplexer (DSLAM) communicatively interfaced with the DSL line;
reporting from a Customer Premises Equipment (CPE) modem communicatively interfaced with the DSL line; and
derived from impulse noise statistics.

23. The method of claim 1, further comprising:
computing the blended noise mitigation strategy using two or more of the impulse noise classes;
weighting each of the two or more of the impulse noise classes to be used in computing the blended noise mitigation strategy; and
wherein computing the blended noise mitigation strategy from the two or more of the impulse noise classes comprises emphasizing the impulse noise classes in the blended noise mitigation strategy having a greatest weighting over all other impulse noise classes among the two or more impulse noise classes having a lesser weighting.

24. The method of claim 1, wherein the measurements corresponding to impulse noise events occurring at the DSL line comprises:
impulse noise data between a leading edge and a trailing edge for each of the respective impulse noises;
rise and fall rates for the leading and trailing edges for each of the respective impulse noises;
leading margin data preceding the leading edge for each of the respective impulse noises; and
trailing margin data following the trailing edge for each of the respective impulse noises.

25. The method of claim 1, wherein the measurements corresponding to impulse noise events occurring at the DSL line comprises for each respective impulse noise event:
a DSL signal sample recorded from the DSL line for a period of time inclusive of:
(i) a signal portion recorded in advance of the impulse noise on the DSL line;
(ii) a signal portion recorded for the duration of the impulse noise on the DSL line; and
(iii) a signal portion recorded after the impulse noise on the DSL line.

26. The method of claim 25, wherein computing the blended noise mitigation strategy comprises:
computing the blended noise mitigation strategy based on at least the signal portions (i), (ii), and (iii) for each of the respective one or more impulse noise classes used.

27. The method of claim 26:
wherein computing the blended noise mitigation strategy comprises using one or more of the impulse noise classes and further using one or more non-impulse noise measurements captured at the DSL line; and
wherein computing the blended noise mitigation strategy further comprises, for each of the one or more impulse noise classes used and for each of the one or more of the non-impulse noise measurements used:
(a) identifying a first frequency band in which noise cancellation is not required,
(b) identifying a second frequency band in which there are known un-correlated noise sources,
(c) creating a first covariance matrix which has large power in each of the first and the second frequency bands identified, and
(d) calculating the blended noise mitigation strategy as a filter coefficient from at least the signal portions (i), (ii), and (iii) for each of the respective one or more impulse noise classes used and calculating the blended noise mitigation strategy based further on the covariance first matrix created at (c) having the large power in each of the first and the second frequency bands identified.

28. The method of claim 26:
wherein computing the blended noise mitigation strategy further includes using the one or more reference signals in the computation;
wherein, for each of the one or more reference signals used, the computing the blended further comprises:
(a) identifying correlated noise with a primary signal, and
(b) computing a power of un-correlated reference noise using correlated noise information from at least the signal portions in (i) and (iii) for each of the respective one or more impulse noise classes used as a filter coefficient by weighting the one or more reference signals using the un-correlated noise power in (ii).

29. The method of claim 1:
wherein computing the blended noise mitigation strategy comprises using two or more of the impulse noise classes; and
wherein computing the blended noise mitigation strategy further comprises, for each of the two or more impulse noise classes used:
(i) identifying the impulse noise signal in the measurement between a leading edge and a trailing edge,
(ii) identifying a trailing signal portion in the measurement following the trailing edge of the impulse noise signal,
(iii) identifying a leading signal portion greater in length than the trailing signal portion identified, the leading signal portion preceding the leading edge of the impulse noise signal,
(iv) calculating a first covariance matrix for each of the two or more impulse noise classes from the leading signal portion, the impulse noise signal, and the trailing edge portion for a first impulse in the measurements corresponding to the first of the two or more impulse noise classes,
(v) calculating a second covariance matrix for a second of the two or more impulse noise classes from the leading signal portion, the impulse noise signal, and the trailing edge portion for a second impulse in the measurements corresponding to the second of the two or more impulse noise classes, and
(vi) calculating the blended noise mitigation strategy as a filter coefficient from the first and the second covariance matrices.

30. The method of claim 1:
wherein the measurements captured from the one or more reference signals are captured at a first DSL network component coupled with the first DSL line;
wherein applying the impulse noise soft switching comprises instructing the first DSL network component coupled with the first DSL line to adopt the blended noise mitigation strategy computed based on clustering information derived from the measurements captured at the first DSL network component coupled with the first DSL line;
wherein the method further comprises passing the clustering information derived from the measurements captured at the first DSL network component to a second DSL network component coupled with a second DSL line;
wherein the second network component is to adopt a second blended noise mitigation strategy computed based at least in part on the clustering information derived from the measurements captured at the first DSL network component; and
wherein the first and the second DSL network components are each separated by a geographic distance less than a threshold or determined to reside within a common geographical neighborhood.

31. The method of claim 30, wherein the second blended noise mitigation strategy is computed based further on channel phases and gains specific to the second DSL line and distinct from channel phases and gains specific to the first DSL line.

32. The method of claim 1, wherein applying the impulse noise soft switching to the DSL line using the blended noise mitigation strategy computed comprises sending the instructions to adopt the blended noise mitigation strategy to one of:
a chipset of a Customer Premises Equipment (CPE) modem communicably interfaced with a first end of the DSL line;
a chipset of a signal conditioning device physically separate and distinct from a Customer Premises Equipment (CPE) modem, wherein the CPE modem is communicably interfaced with the first end of the DSL line and wherein the signal conditioning device is communicatively interfaced to the CPE modem;
a controller card configured within a Customer Premises Equipment (CPE) modem communicably interfaced with the first end of the DSL line; and
a controller card configured within a signal conditioning device physically separate and distinct from a Customer Premises Equipment (CPE) modem, wherein the CPE modem is communicably interfaced with the first end of the DSL line and wherein the signal conditioning device is communicatively interfaced to the CPE modem.

33. Non-transitory computer readable storage media having instructions stored thereon that, when executed by a processor, the instructions cause the processor to perform operations for mitigating noise on a Digital Subscriber Line (DSL line), the operations comprising:
capturing measurements from one or more reference signals, the measurements corresponding to impulse noise events occurring at the DSL line;
classifying the impulse noise events into a plurality of impulse noise classes;
computing a blended noise mitigation strategy using one or more of the impulse noise classes;
applying impulse noise soft switching to the DSL line using the blended noise mitigation strategy computed; and
maintaining the blended noise mitigation strategy at the DSL line for mitigating the impulse noise events on the DSL line.

34. The non-transitory computer readable storage media of claim 33:
wherein the instructions are performed by a DSL service provider or a third party service provider having at least the processor and a memory therein to store the instructions;
wherein applying impulse noise soft switching to the DSL line comprises the third party service provider sending the blended noise mitigation strategy to the DSL modem or to a DSL optimizer coupled with the DSL modem with instructions to apply and maintain the DSL the blended noise mitigation strategy at the DSL line using the blended noise mitigation strategy sent; and
wherein the DSL service provider is responsible for providing DSL communication services to a DSL customer via the DSL line and the third party service provider is an entity separate from the DSL service provider.

35. A system for mitigating noise on a Digital Subscriber Line (DSL line), the system comprising:
a memory and a processor to store and execute instructions;
an impulse noise detector to capture measurements from one or more reference signals, the measurements corresponding to impulse noise events occurring at the DSL line;
a classifier to classify the impulse noise events into a plurality of impulse noise classes;
an analysis engine to determine a blended noise mitigation strategy using one or more of the impulse noise classes;
an impulse noise mitigator to apply impulse noise soft switching to the DSL line using the blended noise mitigation strategy determined; and
wherein the impulse noise mitigator is to maintain the blended noise mitigation strategy at the DSL line for mitigating the impulse noise events on the DSL line.

36. The system of claim 35, wherein the system is to operate at one of:
a DSL service provider responsible for providing DSL communication services to a DSL customer via the DSL line, wherein the DSL service provider is to communicate with a DSL network component coupled with the DSL line via a management interface of the DSL network component; and
a third party service provider operating as a separate entity from the DSL service provider, wherein the third party service provider is to communicate with the DSL network component coupled with the DSL line via a management interface of the DSL network component.

37. The system of claim 35, wherein the system embodied within a DSL network component selected from the group comprising:
a chipset of a Customer Premises Equipment (CPE) modem communicably interfaced with a first end of the DSL line;
a chipset of a signal conditioning device physically separate and distinct from a Customer Premises Equipment (CPE) modem, wherein the CPE modem is communicably interfaced with the first end of the DSL line and wherein the signal conditioning device is communicatively interfaced to the CPE modem;
a controller card configured within a Customer Premises Equipment (CPE) modem communicably interfaced with the first end of the DSL line; and
a controller card configured within a signal conditioning device physically separate and distinct from a Customer Premises Equipment (CPE) modem, wherein the CPE modem is communicably interfaced with the first end of the DSL line and wherein the signal conditioning device is communicatively interfaced to the CPE modem.

38. The system of claim 37, further comprising:
a management interface to communicatively link the DSL network component with a DSL service provider responsible for providing DSL communication services to a DSL customer via the DSL line or a third party service provider operating as a separate entity from the DSL service provider;
wherein the analysis engine to determine the blended noise mitigation strategy using one or more of the impulse noise classes comprises receiving the blended noise mitigation strategy from the DSL service provider or the third party service provider via the management interface; and
wherein the impulse noise mitigator is to apply and maintain the blended noise mitigation strategy at the DSL line responsive to instructions for mitigating the impulse noise events on the DSL line received from the DSL service provider or the third party service provider.

39. The system of claim 38, wherein the blended noise mitigation strategy is to be computed by the DSL service provider or the third party service provider based on the measurements from the one or more reference signals captured by the DSL network component and transmitted to the DSL service provider or the third party service provider via the management interface.
